(19) United States
(12) Patent Application Publication
(10) Pub. No.: US 2020/0258152 A1
(43) Pub. Date: Aug. 13, 2020

(54) SYSTEMS AND METHODS FOR STORAGE OF CRYPTOCURRENCIES AND TRANSACTIONS THEREOF

(71) Applicant: Open Blocks Ltd., Herzliya (IL)

(72) Inventors: Elad NAGGAR, Kadima (IL); Elad HEMAR, Tel-Aviv (IL)

(73) Assignee: Open Blocks Ltd., Herzliya (IL)

(21) Appl. No.: 16/753,783

(22) PCT Filed: Oct. 8, 2018
(86) PCT No.: PCT/IL2018/051089

§ 371 Date: Apr. 5, 2020

Related U.S. Application Data
(60) Provisional application No. 62/569,740, filed on Oct. 9, 2017.

(51) Int. Cl. G06Q 40/04; G06Q 20/06; G06Q 20/36; G06Q 20/38; G06Q 40/02; G06Q 20/10; G06Q 20/32; G06Q 30/00; G06Q 50/26; G06Q 20/40; G06F 9/54; H04L 9/32; H04L 29/06; G06F 3/0481; G06F 3/0482

(52) U.S. Cl. CPC G06Q 40/04; H04L 2209/56; G06Q 20/3678; G06Q 20/3672; G06Q 20/3676; G06Q 20/3821; G06Q 20/3829; G06Q 20/381; G06Q 40/02; G06Q 20/108; G06Q 20/3267; G06Q 30/0185; G06Q 50/265; G06Q 20/405; G06F 9/54; H04L 9/3226; H04L 63/102; G06F 3/04817; G06F 3/0482; G06Q 2220/00; G06Q 20/0655

(57) ABSTRACT

There is provided a system for transferring cryptocurrency, comprising code for: receiving a request for providing a target amount of a target currency to a destination entity according to a corresponding value of a cryptocurrency, wherein the request includes a user credential; accessing, according to the user credential the cryptocurrency stored in a universal wallet stored on a data storage device, wherein the universal wallet stores cryptocurrency according to user credentials of corresponding users, wherein a user dataset stores a mapping between each of the user credentials and amount of cryptocurrency stored in the universal wallet, providing the target amount of the target currency to the destination entity according to the cryptocurrency, and updating the user dataset at least according to corresponding value of the cryptocurrency to indicate a new amount of the cryptocurrency stored in the universal wallet and mapped to the user credential.

### BACKGROUND

The present invention, in some embodiments thereof, relates to cryptocurrencies and, more specifically, but not exclusively, to systems and methods for storing cryptocurrencies and transactions thereof.

Wikipedia (en(dot)wikipedia(dot)org(slash)wiki(slash)Cryptocurrency accessed on Sep. 13, 2018) defines Cryptocurrency as “A cryptocurrency (or crypto currency) is a digital asset designed to work as a medium of exchange that uses strong cryptography to secure financial transactions, control the creation of additional units, and verify the transfer of assets. Cryptocurrencies are a kind of digital currency, virtual currency or alternative currency. Cryptocurrencies use decentralized control as opposed to centralized electronic money and central banking systems. The decentralized control of each cryptocurrency works through distributed ledger technology, typically a blockchain, that serves as a public financial transaction database.”

### SUMMARY

According to a first aspect, a system for transferring cryptocurrency, comprises: at least one hardware processor, a non-transitory memory stored thereon code for execution by the at least one hardware process, the code including instructions for: receiving a request from a client terminal over a network, for providing a target amount of at least one target currency to a destination entity according to a corresponding value of at least one cryptocurrency, wherein the request includes a user credential, accessing, according to the user credential the at least one cryptocurrency stored in at least one universal wallet stored on a data storage device, wherein the at least one universal wallet stores cryptocurrency according to a plurality of user credentials of a corresponding plurality of users, wherein a user dataset stores a mapping between each of the plurality of user credentials and amount of cryptocurrency stored in the at least one universal wallet, and generating instructions for providing the target amount of the at least one target currency to the destination entity according to the at least one cryptocurrency, and updating the user dataset at least according to corresponding value of the at least one cryptocurrency to indicate a new amount of the at least one cryptocurrency stored in the at least one universal wallet and mapped to the user credential.

According to a second aspect, a system for obtaining at least one cryptocurrency, comprises: at least one hardware processor, a non-transitory memory stored thereon code for execution by the at least one hardware process, the code including instructions for: receiving a request from a client terminal over a network, for obtaining a target amount of at least one target cryptocurrency according to a corresponding value of a source currency, wherein the request includes a user credential, obtaining an amount of a source currency corresponding to the target amount of the at least one target cryptocurrency, converting the amount of the source currency to the target amount of the at least one target cryptocurrency, storing, according to the user credential, the target amount of the at least one target cryptocurrency in at least one universal wallet stored on a data storage device, wherein the universal wallet stores cryptocurrency according to a plurality of user credentials of a corresponding plurality of users, wherein a user dataset stores a mapping between each of the plurality of user credentials and amount of cryptocurrency stored in the at least one universal wallet, and updating the user dataset at least according to corresponding value of the at least one target cryptocurrency to indicate a new amount of the at least one cryptocurrency stored in the at least one universal wallet and mapped to the user credential.

According to a third aspect, a system for managing FIAT and cryptocurrency using a single GUI, comprises: at least one hardware processor, a non-transitory memory stored thereon code for execution by the at least one hardware process, the code including instructions for: generating instructions for presenting, within a GUI on a display of a client terminal, at least one icon presented within a single common interface for performing at least one transaction including at least one FIAT currency and at least one cryptocurrency, wherein the FIAT currency is stored in at least one FIAT financial account hosted by a financial server, wherein the at least one cryptocurrency is stored in at least one universal wallet on a data storage server, wherein the at least one universal wallet stores cryptocurrency according to a plurality of user credentials of a corresponding plurality of users, wherein a user dataset stores a mapping between each of the plurality of user credentials and amount of cryptocurrency stored in the at least one universal wallet and FIAT financial accounts, in response to the selection of the at least one icon for performing the at least one transaction, updating the user dataset to indicate a new amount of the at least one cryptocurrency stored in the at least one universal wallet and mapped to the user credentials, wherein a new amount of the at least one FIAT currency stored in the FIAT financial account is updated according to the selection of the at least one icon for performing the at least one transaction.

At least one some of the implementation of the systems, methods, apparatus, and/or code instructions described herein address the technical problem of using cryptocurrency to perform financial transactions via a network (e.g., a website of an online store) where the financial transactions are performed using FIAT currency and/or non-cryptographic currency. In particular, the technical problem relates to performing such FIAT currency based financial transactions with existing websites without the website being aware that cryptocurrency is being used, and/or without the website installing addition code for interfacing with the cryptocurrency (although in some implementations the installation of the interface code on the website code is performed). For example, a user wishes to use Bitcoin to pay for a physical item (e.g., book, backpack, clothes) being purchased at an online retailer that only accepts US dollars (or other FIAT currency such as Euros, Yen, and Pounds) as payment. At least one some of the implementation of the systems, methods, apparatus, and/or code instructions described herein enable users to use cryptographic currency to perform network financial transactions where only non-cryptographic is accepted. In some implementations, an add-on to a browser rendering the website is provided, where the add-on creates a graphical user interface (GUI) that includes a selection mechanism for a user to use cryptocurrency instead of FIAT. For example, a window including a button for selection is inserted into the rendering of the website. When the user selects (e.g., single click, single touch) the button, the process of using cryptocurrency for payment (i.e., via conversion into the FIAT currency, as described herein) is triggered, as described herein.

Conceptually, at least one some of the implementation of the systems, methods, apparatus, and/or code instructions described herein turn cryptocurrency into “real money”.

The universal wallet, which stores cryptocurrency (optionally multiple cryptocurrencies) for multiple users improves computational performance of the computing device that stores and/or manages the wallet. In contrast to standard processes in which each user requires at least one private wallet to store cryptocurrency and perform transactions, a single universal wallet may be used by multiple users to store cryptocurrency and perform transactions. The universal wallet(s), which number much fewer than the number of personal wallets that would otherwise be required when one personal wallet is used per user, may be stored more securely than storing a larger number of wallet. The universal wallet may be managed in a computationally efficient manner by an index mapping to user credentials with central access rather than each user accessing their own wallet as is done using standard processes. Transfer of cryptocurrency between users may be performed in a computationally efficiency manner and/or more secure manner by updating the index mapping the users to the cryptocurrency, in contrast to transferring the cryptocurrency between private wallets of the users are currently performed. Moreover, transfer of cryptocurrency between users may be performed without updating the main blockchain ledger of the cryptocurrency, which is more computationally efficient, in contrast to standard methods which require updating of the main blockchain ledger of the cryptocurrency for each transaction between private wallets. Moreover, transfer of cryptocurrency, optionally conversion between different types of cryptocurrencies may be performed by update of the user dataset and/or transaction dataset without updating the main blockchain ledger of the cryptocurrency, which is more computationally efficient, in contrast to standard methods.

At least one some of the implementation of the systems, methods, apparatus, and/or code instructions described herein address the technical problem of improving the user experience of performing transactions using cryptocurrency, for example, reducing processing time required for the transaction to be executed, and/or reducing technical complexity associated with the transaction. At least some implementations act as a management layer over the existing blockchain based cryptocurrency blockchain and/or ledger, removing the requirement for users to access personal wallets for performing cryptocurrency transactions, and/or removing the requirement of updating the blockchain ledger for every cryptocurrency transaction. The reduction and/or removal of the requirement to access the blockchain for verification of the transaction reduces the processing time for implementing the transaction, may be performed with relatively reduced or no mining fee, relatively reduced or no volatility risks due to crypto/FIAT instant conversion performed external to the ledger via exchange API's and/or universal wallets combination and flow, as described herein.

At least one some of the implementation of the systems, methods, apparatus, and/or code instructions described herein address the technical problem of cybersecurity, in particular, to providing security of digital wallets storing digital currency. Using existing methods, users store cryptocurrencies in a personal wallet. Users must hold non-secure digital assets to access the personal wallet. Transfer of the cryptocurrencies is performed between personal wallets, by sending from one wallet to an address of another wallet. The addresses may be defined as hash keys. Access to the digital wallet may be in the form of a private key. When security is breached by a malicious entity and the private key is obtained, the malicious entity may steal the digital currency stored in the wallet by transfer from the breached wallet to an anonymous wallet owned by the malicious entity.

At least one some of the implementation of the systems, methods, apparatus, and/or code instructions described herein provide a technical solution to the technical problem of securing digital wallets by preventing access of users to the digital wallet. Conceptually, some implementations provide a personal wallet free architecture, where users are not provided with personal wallets, and do not interact with such personal wallets. Instead, a universal wallet that serves multiple users (i.e., cryptocurrency of multiple users is stored in the universal wallet) is provided. A management layer controls the universal wallet, and acts as an interface between user credentials of users and cryptocurrencies stored in the universal wallet, utilizing universal ID's for example, email, phone number, or any other universal ID and/or non universal ID. The management layer performs transactions of cryptocurrencies using the universal wallet based on user credentials rather than the users accessing private wallets. The management layer may provide rule based transactions, for example, for purchase of a bag of multiple cryptocurrencies (e.g., predefined ratios and/or amounts), and/or for purchase and/or sale of cryptocurrencies at defined events (e.g., after a decrease of 20%), optionally with a single selection (e.g., single click of a mouse, and/or single touch of a finger on a touch screen) of the bag and/or of the defined rule(s).

Users access cryptocurrencies stored in a universal wallet using user credentials (e.g., email, phone number, user name) that may be associated with a real user, rather than accessing the wallet using the wallet address. Direct access to the universal wallet by users may be prevented, and/or denied, preventing direct tampering with the contents of the universal wallet. Transactions of cryptocurrencies are not necessarily performed to another wallet of another user, but rather, according to the user credentials of another user. The transaction may be performed using the same universal wallet, by updating a registry that maps between user credentials and amount stored in the universal wallet. The removal of direct access to the wallets by the users prevents or reduces malicious activity arising from the anonymity inherent in the wallet addresses, since the user credentials are directly tied to a real user.

At least one some of the implementation of the systems, methods, apparatus, and/or code instructions described herein address the technical problem of cybersecurity, in particular, to providing security of digital wallets storing digital currency hosted by a server. Using existing methods, in which servers, such as digital coin exchanges, have access to wallets of users, a breach to the server by a malicious entity provides access to a large number of wallets from which the cryptocurrency may be stolen. For example, a hacker may access a million wallets of a digital coin exchange, and transfer funds stored by the wallets (e.g., equivalent to $50 million) into an anonymous wallet owned by the hacker.

At least one some of the implementation of the systems, methods, apparatus, and/or code instructions described herein address the technical problem of purchasing multiple types of cryptocurrencies. Using existing methods, each type of cryptocurrency requires a separate transaction issued to the exchange server and/or service site. For example, purchasing 4 coins of a certain amount (e.g., 30 Bitcoin, 10 Ethereum, 5 Dash, 5 Ripple coins) requires 4 transactions. The multiple transactions reduce the computational efficiency of the client terminal of the user issuing the transactions, the network that transfers the transactions, and the server(s) that execute the transactions, and/or remove the need for users to store and/or manage multiple personal wallet types required for different types of crypto currencies, as the universal wallet(s) store and/or manage different types of cryptocurrencies for multiple users without the user directly managing the universal wallet(s) themselves. For clarification, existing exchanges allow a user to buy various types of currencies (optionally cryptocurrencies) on the exchange—but it is different than at least some of the implementation of the systems, methods, apparatus, and/or code instructions described herein, as in the exchanges it is a “virtual position” on a digital asset” and not the ability to use cryptocurrency as “real money” to pay and/or buy as described herein. In contrast, at least one some of the implementation of the systems, methods, apparatus, and/or code instructions described herein improve user experience of multi-cryptocurrency transactions, and/or improve computational efficiency of client terminals and/or networks and/or servers, by providing a feature for purchase and/or sale of multi-cryptocurrency (e.g. multi-coin) coins with a single click. The feature offers pre-defined and/or defined on the fly bundles of various cryptocurrencies (e.g., coins), for example, a certain percentages and/or number of coins of each type. Alternatively, users may create their own bundles and/or mix and match bundles.

At least one some of the implementation of the systems, methods, apparatus, and/or code instructions described herein address the technical problem of complexity of architectures based on personal digital wallets. Such architecture, as currently defined, is complex, requiring complex technical processing for activating such wallets, buying digital currency using the wallet, storing the digital currency in the wallet. Moreover, the anonymous design of the architecture is difficult for non-technical users to use. In contrast, at least one some of the implementation of the systems, methods, apparatus, and/or code instructions described herein does not use client side personal wallets, but replaces the client side personal wallet with server side temporary wallets and server side universal wallets. User may perform cryptocurrency transactions (e.g., send, receive, buy, sell, add, withdraw) using user credentials (e.g., user ID, email address, phone number), with improved user experience due to reduced complexity.

At least one some of the implementation of the systems, methods, apparatus, and/or code instructions described herein improve the technical field of cybersecurity, in particular, cybersecurity of cryptocurrencies. Existing architectures for storing and/or trading cryptocurrencies are insecure, not only at the server/exchange security level, but also at the user security level, such as actions required to be performed by the user to secure cryptocurrency coins owned by the user. At least one some of the implementation of the systems, methods, apparatus, and/or code instructions described herein remove existing client side personal wallets which are managed and stored by users, and operate without such personal wallets. The removal of the personal wallet improves user experience of performing cryptocurrency transactions since users do not need to worry about security their personal wallet client side. Access of malicious entities to the personal wallet is nonexistent due to the removal of the persona wallet.

At least one some of the implementation of the systems, methods, apparatus, and/or code instructions described herein address the technical problem of efficiently managing cryptocurrency and FIAT currency, which are traditionally stored in different data structures and/or different storage devices that are unrelated. The GUI and/or client code and/or architecture described herein provides a single interface for a user, allowing the user to execute transactions using both FIAT and cryptocurrency from the single interface. The single interface may be an add-on to the GUI provided by the financial server when accessing a financial account, providing enhanced features for the GUI not available in traditional GUIs of FIAT financial accounts, for example, providing accessing to the cryptocurrency of the user, and/or providing the user with options to perform transactions using both (or any one of) the cryptocurrencies and FIAT currency.

In a further implementation form of the first aspect, the target currency comprises cryptocurrency, further comprising updating the user dataset according to the target cryptocurrency to indicate a new amount of the at least one cryptocurrency stored in the at least one universal wallet and mapped to credentials of the destination entity.

In a further implementation form of the first aspect, the target currency is different than the at least one cryptocurrency, converting the at least one cryptocurrency to the target amount of the at least one target currency.

In a further implementation form of the first aspect, the system further comprises instructions for: accessing an empty temporary wallet stored on a memory, disconnecting the temporary wallet from a network connection, synchronizing, when offline and disconnected from the network connection, an amount of the at least one cryptocurrency corresponding to the target amount of the target currency with the temporary wallet, wherein the universal wallet is stored in a first data storage device disconnected from the network connection, wherein the temporary wallet is stored in a second data storage device connected to the network connection, and re-connecting the temporary wallet to the network connection.

In a further implementation form of the first aspect, the empty temporary wallet is a new temporary wallet created for each transaction of providing cryptocurrency.

In a further implementation form of the first aspect, the empty temporary wallet is an existing temporary wallet used for temporary storage of cryptocurrency for another user, wherein the temporarily stored cryptocurrency is removed to create the empty temporary wallet.

In a further implementation form of the first aspect, a single universal wallet stores cryptocurrency for a plurality of users according to a plurality of user credentials.

In a further implementation form of the first aspect, an amount of a same type of cryptocurrency of a certain user is divided and stored by a plurality of universal wallets each designed to store the same type of cryptocurrency.

In a further implementation form of the first aspect, the user credentials is selected from the group consisting of: email, phone number, username, a universal, and a non universal ID.

In a further implementation form of the first aspect, the system further comprises code for a mapping database storing a mapping between user credentials and amount of at least one cryptocurrency stored in the at least one universal wallet.

In a further implementation form of the first aspect, the mapping database is stored in a data storage device disconnected from the network connection, and the user data is updated offline according to the synchronization of a temporary wallet and the at least one universal wallet.

In a further implementation form of the first aspect, the converting comprise generating instructions for execution by an application programming interface (API) of at least one exchange server for exchanging an amount of the at least one cryptocurrency into the target amount of the target currency.

In a further implementation form of the first aspect, the target currency comprises a FIAT currency, and the generated instructions include instructions for depositing the target amount of the target currency into a financial account of the destination entity stored by a financial server.

In a further implementation form of the first aspect, the target currency comprises a FIAT currency, and the generated instructions include instructions for transferring the target amount of the target currency to a website of the destination entity.

In a further implementation form of the first aspect, the system further comprising client code for installation by a financial server hosting FIAT financial accounts of users, wherein the client code includes instructions for presenting within a GUI during access of a certain FIAT financial account, an object that when selected provides the request from the client terminal accessing the certain financial account of the financial server.

In a further implementation form of the first aspect, the system further comprising client code for installation by the client terminal as an add-on to a browser executed by the client terminal, wherein the client code includes code for interfacing with a website rendered by the browser and for transmitting the request for transferring the target amount of the target currency to the destination entity according to the corresponding value of at least one cryptocurrency, wherein the destination entity comprises the website.

In a further implementation form of the first aspect, the code includes instructions for presenting a graphical user interface (GUI) for manual user selection of execution of the request of transferring the target amount of the target currency to the website according to the corresponding value of the at least one cryptocurrency.

In a further implementation form of the first aspect, the code includes instructions for presenting a GUI that presents the corresponding value of the at least one cryptocurrency.

In a further implementation form of the first aspect, the client code includes instructions to set the target amount and the target currency for the destination entity according to the website.

In a further implementation form of the first aspect, the GUI is presented as a window inserted into the rendered website, and wherein the GUI includes a button for manual selection by the user for execution of the request.

In a further implementation form of the first aspect, the manual user selection triggers payment of the target amount of the target currency to the website for purchase of at least one item or service using the corresponding value of the at least one cryptocurrency.

In a further implementation form of the first aspect, the website comprises a website in which a payment and/or purchase of items or service is provided, and the target amount and the target currency are set according at least one item presented on the website and available for purchase via the website.

In a further implementation form of the first aspect, the code includes instructions for presenting a GUI for user selection of the at least one cryptocurrency according to cryptocurrencies stored in the universal wallet and mapped to the user credentials.

In a further implementation form of the first aspect, the system further comprises client code for installation as an independent application by a mobile device implemented as the client terminal, wherein the client code includes code for interfacing with a website and for transmitting the request for transferring the target amount of the target currency to the destination entity according to the corresponding value of at least one cryptocurrency, wherein the destination entity comprises the website.

In a further implementation form of the first aspect, the target currency is a FIAT currency.

In a further implementation form of the first aspect, an address of the universal wallet is recorded in a ledger stored in a blockchain dataset that stores records of cryptocurrency transactions.

In a further implementation form of the first aspect, the at least one cryptocurrency stored in the universal wallet is transferred to a non-wallet data structure associated with the destination entity.

In a further implementation form of the first aspect, the target amount of the target currency converted from the at least one cryptocurrency is provided to the destination entity according to user credentials of the destination entity and the user credentials and not according to private wallet addresses of the destination entity and the user associated with the user credentials.

In a further implementation form of the first aspect, a user associated with the user credentials is denied direct access to the universal wallet for direct deposit and/or withdrawal of cryptocurrency.

In a further implementation form of the first aspect, the system further comprises a user dataset storing mapping between a plurality of user credentials and corresponding amounts of at least one cryptocurrency stored in the universal wallet, and wherein when the destination entity comprises a destination user credential stored in the user dataset, the generated instructions for providing the target amount of the target currency to the destination entity comprises instructions for updating the user dataset.

In a further implementation form of the first aspect, the user dataset is updated and an external distributed ledger blockchain dataset storing records of cryptocurrency transactions is not updated.

In a further implementation form of the first aspect, the system further comprises instructions for: storing the request in a transaction dataset stored in a memory in communication with a network connection, disconnecting the memory from the network connection, synchronizing when offline and disconnected from the network connection, the transaction dataset with a mapping dataset and the universal wallet, the mapping dataset and the universal wallet stored on a data storage device disconnected from the network connection, wherein the mapping dataset stores a mapping between each of a plurality of user credentials and amount of each of a plurality of cryptocurrencies stored in the at least one universal wallet, and updating the user dataset according to the transaction dataset and in response to the synchronization.

In a further implementation form of the first aspect, the user credential and the destination user credential are selected from the group consisting of: email, phone number, username, universal ID, or non-universal ID.

In a further implementation form of the first aspect, the target amount of the target currency is provided to the destination entity using the same universal wallet that stores at least one cryptocurrency for the user credentials and for the destination user credential by updating the user dataset to indicate transfer of ownership of the target currency from the destination user credentials to the user credentials without transfer of the target amount of the target currency out of the same universal wallet.

In a further implementation form of the first aspect, the system further comprises a user dataset storing mapping between a plurality of user credentials and corresponding amounts of at least one cryptocurrency stored in the universal wallet, and wherein when the destination entity comprises a destination user credential not stored in the user dataset, further comprising instructions for transmitting a link to the destination user credentials to set up a record in the user dataset, and wherein the generated instructions for providing the target amount of the target currency to the destination entity comprises instructions for updating the user dataset according to the record of the destination user credential.

In a further implementation form of the first aspect, the system further comprises code for: converting the at least one cryptocurrency to a target amount of a FAIT of the at least one target currency, wherein the destination entity comprises a FIAT financial account hosted by a financial server associated with the user credentials, wherein the at least one cryptocurrency is withdrawn from the universal wallet associated with the user credential and deposited as the target amount of the at least one target currency in the FIAT financial account associated with the user credentials, wherein the user dataset stores a mapping of the FIAT financial account and the user credentials.

In a further implementation form of the second aspect, the system further comprises instructions for: storing the target amount of the at least one target cryptocurrency in a temporary wallet stored on a memory in communication with a network connection, disconnecting the temporary wallet from the network connection, and synchronizing, when offline and disconnected from the network connection, the target amount of the at least one target cryptocurrency stored in the temporary wallet with the universal wallet stored in a data storage device disconnected from the network connection.

In a further implementation form of the second aspect, the system further comprises instructions for: removing the contents of the temporary wallet to empty the temporary wallet, and re-connecting the temporary wallet to the network connection.

In a further implementation form of the second aspect, the temporary wallet comprises a same temporary wallet used by a plurality of discrete users.

In a further implementation form of the second aspect, the system further comprises instructions for: deleting the temporary wallet or blocking further access to the temporary wallet, and creating a new temporary wallet connected to the network connection, for storage of a new target amount of at least one new target cryptocurrency.

In a further implementation form of the second aspect, the target amount of each type of cryptocurrency of a certain user is divided and stored by a plurality of universal wallets each designed to store the same type of cryptocurrency.

In a further implementation form of the second aspect, the source currency is a FIAT currency. In a further implementation form of the second aspect, the target amount is according to a selection from a set of predefined rules defining a plurality of combinations of a plurality of target cryptocurrencies.

In a further implementation form of the second aspect, the target amount is selected with a single click from a graphical user interface (GUI) that displays the plurality of combinations of the plurality of target cryptocurrencies, and wherein the selected combination of the plurality of target cryptocurrencies is obtained by converting the amount of the source currency to the target amount of the at least one target cryptocurrency in response to the single click.

In a further implementation form of the second aspect, the plurality of combinations are of at least one of: initial coin offerings (ICO), and security token offerings, wherein the target amount of the plurality of combinations is selected with a single click from a GUI, wherein in response to the single click user data is automatically transferred for automatic registration of a user associated with the user credentials for obtaining the selected combination of at least one of: initial coin offerings (ICO), and security token offerings.

In a further implementation form of the second aspect, converting comprises generating instructions for execution by an application programming interface (API) of an exchange server for obtaining the target amount of the at least one target cryptocurrency.

In a further implementation form of the second aspect, the system further comprises instructions for obtaining FIAT from a financial server storing financial data of a user using the client terminal and associated with the user credentials, and wherein the FIAT is converted to the target amount of the at least one target cryptocurrency.

In a further implementation form of the third aspect, the at least one transaction including at least one FIAT currency and at least one cryptocurrency is selected from the group consisting of: obtaining additional at least one cryptocurrency using the at least one FIAT currency, converting from the at least one cryptocurrency to the at least one FIAT currency, converting from the at least one FIAT currency to the at least one cryptocurrency, providing from the at least one cryptocurrency to a destination entity, providing from the at least one FIAT currency to a destination entity, withdrawing from the at least one cryptocurrency and transferring a corresponding converted amount to the at least one FIAT currency, providing a request to receive an amount of at least one cryptocurrency from a target entity, and providing a request to receive an amount of at least one FIAT currency from a target entity.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for performing transactions using cryptocurrency stored in a universal wallet that stores cryptocurrency for multiple users according to corresponding user credentials, in accordance with some embodiments of the present invention;

FIG. 2 is a flowchart of a high level process for performing transactions of digital currency stored in a universal wallet, in accordance with some embodiments of the present invention;

FIG. 3 is a flowchart of a process for obtaining digital currency (optionally at least including cryptocurrency) stored and/or for storing in a universal wallet, in accordance with some embodiments of the present invention;

FIG. 4 is a flowchart of a process for providing digital currency (optionally at least including cryptocurrency) stored in a universal wallet, in accordance with some embodiments of the present invention;

FIGS. 5A-5T include schematics of an exemplary GUI for accessing cryptocurrency stored in a universal wallet and/or for performing transactions using the cryptocurrency, in accordance with some embodiments of the present invention; and

FIG. 6 is a flowchart of an exemplary process for requesting to be provided with a target amount of a target currency by another user, in accordance with some embodiments of the present invention.

### DETAILED DESCRIPTION

The present invention, in some embodiments thereof, relates to cryptocurrencies and, more specifically, but not exclusively, to systems and methods for obtaining and/or storing cryptocurrencies, and transactions thereof.

As used herein, the term cryptocurrency may sometimes be replaced with the term digital currency, or virtual currency. Exemplary cryptocurrencies include: Bitcoin, Ethereum, Dash, Ripple, and the like.

As used herein, the term cryptocurrency may sometimes be replaced with the term non-FIAT currency.

As used herein, the term FIAT currency may sometimes be replaced with the term non-cryptographic currency.

An aspect of some embodiments of the present invention relates to systems, an apparatus, methods, and/or code instructions (i.e., stored in a data storage device and executable by one or more hardware processors) for transferring of cryptocurrency to a destination entity. A request is received from a client terminal over a network, for providing a target amount of a target currency to a destination entity according to a corresponding value of one or more cryptocurrencies, optionally a selected cryptocurrency. For example, providing an amount of Bitcoin corresponding to $100. The request is associated with a user credential, for example, a user name, phone number, and/or email address or any other universal and/or unique ID. Cryptocurrency stored in a universal wallet is accessed according to the user credential, optionally based on a user dataset that maps between user credentials and corresponding amount of cryptocurrency stored in the universal wallet. Users do not require personal wallets and/or do not need to manage the wallet directly via a wallet address and/or wallet key (e.g., hash value). Each universal wallet stores cryptocurrency of a certain types for multiple users according to corresponding user credentials. The cryptocurrency is converted to the target amount of the target currency. Instructions for providing the target amount of the target currency to the destination entity are generated. The target amount of the target currency may be provided, for example, as payment to an ecommerce website, thereby enabling a user to pay using cryptocurrency for items sold by the website for which the website only accepts FIAT currency. In another implementation, the target amount of the target currency, optionally cryptocurrency, is provided according to the user credentials of the destination entity, for example, via email to email crypto payment made via an email message sent to the email address of the destination entity. Such transfer based on user credentials may be performed by updating the user dataset to indicate that the transferred amount of cryptocurrency stored in the universal wallet is mapped to the user credentials of the destination entity. The transfer may be performed without updating an external blockchain dataset ledger that stores transactions of cryptocurrencies according to a defined protocol. The user dataset is updated according to indicate a new amount of the cryptocurrency stored in the universal wallet and mapped to the user credential. When the target currency is cryptocurrency, the user dataset is updated according to the target cryptocurrency to indicate a new amount of the cryptocurrency stored in the universal wallet and mapped to credentials of the destination entity.

Optionally, the universal wallet is stored offline on a cold data storage device. Temporary wallets may be used to transfer cryptocurrency to and/or from the universal wallet. The temporary wallets may store only the cryptocurrency for the current transaction, and may be created and deleted per transaction, and/or emptied and re-used for each transaction. Alternatively, temporary wallets are not implemented.

Optionally, client code is installed as an add-on to a browser executed by a client terminal. The client code may present a graphical user interface (GUI) such as a selection object (e.g., button), meta data, data from an existing user crypto ownership in universal wallet(s), ability to obtain crypto currencies, and/or added to a universal wallet(s) data set (e.g., “signup/join the network”), and/or FIAT payment from a user financial account that is inserted into the rendering of the ecommerce website. The selection object enables payment to the website for purchase of an item using cryptocurrency for websites that only accept FIAT currency.

Optionally the buying is enabled on the client side, for example, on a browser, mobile web, mobile app, 3rd party mobile apps, and/or server code. Enabling the user, for example, to make a purchase using cryptocurrency (e.g., Bitcoin balance) and the payment on the website is transparent, meaning the merchant receives FIAT (e.g., USD) without necessarily being aware that Bitcoin was used.

An aspect of some embodiments of the present invention relates to systems, an apparatus, methods, and/or code instructions (i.e., stored in a data storage device and executable by one or more hardware processors) for obtaining one or more cryptocurrencies. A request is received from a client terminal over a network, for obtaining a target amount of one or more target cryptocurrencies according to a corresponding value of a source currency. The request includes user credentials of a user. An amount of a source FIAT currency and/or other owned crypto currency corresponding to the target amount of the target cryptocurrency may be obtained from a financial server, for example, from a bank account of the user, from a credit card of the user, from a debit card of the user, from a gift card of the user, an automatically connected bank account and/or other FIAT financial account and/or crypto account of a user (e.g., bank, saving, trading account, white label, automatic bank account connection, and the like connected via an API (or other interface) and/or from any another financial account and/or financial source of the user. The amount of the source currency is converted to the target amount of the target cryptocurrency. The target amount of the target cryptocurrency is stored in a universal wallet/s? stored on a data storage device. The universal wallet stores cryptocurrency from multiple users according to a user dataset that maps between user credentials and corresponding amount of cryptocurrency stored in the universal wallet(s).

Optionally, the cryptocurrency stored in the universal wallet cannot be transferred to an external private wallet. The cryptocurrency stored in the universal wallet may be converted into FIAT and deposited into an account of the user hosted by the financial server. In another implementation, the cryptocurrency stored in the universal wallet may be transferred to other user credentials of another user. In such implementation, the cryptocurrency may remain in the same universal wallet. The user dataset may be updated to reflect the new ownership of the cryptocurrency according to the user credentials of the other user.

Optionally, a selected combination of a predefined set of cryptocurrencies is purchased using a single click. Alternatively or additionally, one or more predefined transactions are performed according to a set of rules using a single click, for example, purchasing the top 3 cryptocurrencies that had the highest percentage gain over the last 3 days, or for example, a predefined percentage breakdown of various crypto currencies to be obtained in a single transaction/click for example, 20% Bitcoin, 20% Ether, 30% Monero, 30% Zcash or any other predefined combination. A combination self defined by the user via input/choice of crypto currencies and/or percentages may be used.

An aspect of some embodiments of the present invention relates to systems, an apparatus, methods, and/or code instructions (i.e., stored in a data storage device and executable by one or more hardware processors) for a single interface for managing FIAT and cryptocurrency, for example, a single GUI that provides transactions using FIAT and cryptocurrency within a single interface. Instructions are generated for presenting, within the GUI on a display of a client terminal, which may be accessing the FIAT financial account hosted by a financial server, for example, a bank, a financial instrument trading account, and a credit card account. The GUI includes one or more icons presented within the single common interface for performing one or more transactions including one or more FIAT currencies and one or more cryptocurrencies, for example, buttons, and/or links. Exemplary transactions are as described herein, for example, obtaining additional cryptocurrency using FIAT currency, buying items from websites using cryptocurrency, transferring a selected currency (FIAT and/or cryptocurrency) to a destination entity, receiving a requested currency from a target entity, and/or converting between cryptocurrencies and FIAT currencies. The FIAT currency is stored in at least one FIAT financial account hosted by a financial server, for example, using standard methods. The at least one cryptocurrency is stored in universal wallet(s), where the universal wallet(s) store cryptocurrency according to multiple user credentials of users, as described herein. A user dataset stores a mapping between each of the user credentials and amount of cryptocurrency stored in the universal wallet(s) and FIAT financial accounts. For example, the user logs into their FIAT financial account, which is linked via the user dataset to the amount of cryptocurrency stored in the universal wallet(s). In response to the selection of the icon(s) for performing transaction(s), the user dataset is updated to indicate a new amount of the at least one cryptocurrency stored in the universal wallet(s) and mapped to the user credentials, and a new amount of the at least one FIAT currency stored in the FIAT financial account is updated according to the selection of the icon for performing the transaction(s). Update of the FIAT currency may be performed by the FIAT financial server.

Exemplary transactions include: obtaining additional at least one cryptocurrency using the at least one FIAT currency, converting from the at least one cryptocurrency to the at least one FIAT currency, converting from the at least one FIAT currency to the at least one cryptocurrency, providing from the at least one cryptocurrency to a destination entity, providing from the at least one FIAT currency to a destination entity, withdrawing from the at least one cryptocurrency and transferring a corresponding converted amount to the at least one FIAT currency, providing a request to receive an amount of at least one cryptocurrency from a target entity, and providing a request to receive an amount of at least one FIAT currency from a target entity.

At least one some of the implementation of the systems, methods, apparatus, and/or code instructions described herein address the technical problem of efficiently managing cryptocurrency and FIAT currency, which are traditionally stored in different data structures and/or different storage devices that are unrelated. The GUI and/or client code and/or architecture described herein provides a single interface for a user, allowing the user to execute transactions using both FIAT and cryptocurrency from the single interface. The single interface may be an add-on to the GUI provided by the financial server when accessing a financial account, providing enhanced features for the GUI not available in traditional GUIs of FIAT financial accounts, for example, providing accessing to the cryptocurrency of the user, and/or providing the user with options to perform transactions using both (or any one of) the cryptocurrencies and FIAT currency.

At least one some of the implementation of the systems, methods, apparatus, and/or code instructions described herein address the technical problem of using cryptocurrency to perform financial transactions via a network (e.g., a website of an online store) where the financial transactions are performed using FIAT currency and/or non-cryptographic currency. In particular, the technical problem relates to performing such FIAT currency based financial transactions with existing websites without the website being aware that cryptocurrency is being used, and/or without the website installing addition code for interfacing with the cryptocurrency (although in some implementations the installation of the interface code on the website code is performed). For example, a user wishes to use Bitcoin to pay for a physical item (e.g., book, backpack, clothes) being purchased at an online retailer that only accepts US dollars (or other FIAT currency such as Euros, Yen, and Pounds) as payment. At least one some of the implementation of the systems, methods, apparatus, and/or code instructions described herein enable users to use cryptographic currency to perform network financial transactions where only non-cryptographic is accepted. In some implementations, an add-on to a browser rendering the website is provided, where the add-on creates a graphical user interface (GUI) that includes a selection mechanism for a user to use cryptocurrency instead of FIAT. For example, a window including a button for selection is inserted into the rendering of the website. When the user selects (e.g., single click, single touch) the button, the process of using cryptocurrency for payment (i.e., via conversion into the FIAT currency, as described herein) is triggered, as described herein.

Conceptually, at least one some of the implementation of the systems, methods, apparatus, and/or code instructions described herein turn cryptocurrency into “real money”.

The universal wallet, which stores cryptocurrency (optionally multiple cryptocurrencies) for multiple users improves computational performance of the computing device that stores and/or manages the wallet. In contrast to standard processes in which each user requires at least one private wallet to store cryptocurrency and perform transactions, a single universal wallet may be used by multiple users to store cryptocurrency and perform transactions. The universal wallet(s), which number much fewer than the number of personal wallets that would otherwise be required when one personal wallet is used per user, may be stored more securely than storing a larger number of wallet. The universal wallet may be managed in a computationally efficient manner by an index mapping to user credentials with central access rather than each user accessing their own wallet as is done using standard processes. Transfer of cryptocurrency between users may be performed in a computationally efficiency manner and/or more secure manner by updating the index mapping the users to the cryptocurrency, in contrast to transferring the cryptocurrency between private wallets of the users are currently performed. Moreover, transfer of cryptocurrency between users may be performed without updating the main blockchain ledger of the cryptocurrency, which is more computationally efficient, in contrast to standard methods which require updating of the main blockchain ledger of the cryptocurrency for each transaction between private wallets. Moreover, transfer of cryptocurrency, optionally conversion between different types of cryptocurrencies may be performed by update of the user dataset and/or transaction dataset without updating the main blockchain ledger of the cryptocurrency, which is more computationally efficient, in contrast to standard methods.

At least one some of the implementation of the systems, methods, apparatus, and/or code instructions described herein address the technical problem of improving the user experience of performing transactions using cryptocurrency, for example, reducing processing time required for the transaction to be executed, and/or reducing technical complexity associated with the transaction. At least some implementations act as a management layer over the existing blockchain based cryptocurrency blockchain and/or ledger, removing the requirement for users to access personal wallets for performing cryptocurrency transactions, and/or removing the requirement of updating the blockchain ledger for every cryptocurrency transaction. The reduction and/or removal of the requirement to access the blockchain for verification of the transaction reduces the processing time for implementing the transaction, may be performed with relatively reduced or no mining fee, relatively reduced or no volatility risks due to crypto/FIAT instant conversion performed external to the ledger via exchange API's and/or universal wallets combination and flow, as described herein.

At least one some of the implementation of the systems, methods, apparatus, and/or code instructions described herein address the technical problem of cybersecurity, in particular, to providing security of digital wallets storing digital currency. Using existing methods, users store cryptocurrencies in a personal wallet. Users must hold non-secure digital assets to access the personal wallet. Transfer of the cryptocurrencies is performed between personal wallets, by sending from one wallet to an address of another wallet. The addresses may be defined as hash keys. Access to the digital wallet may be in the form of a private key. When security is breached by a malicious entity and the private key is obtained, the malicious entity may steal the digital currency stored in the wallet by transfer from the breached wallet to an anonymous wallet owned by the malicious entity.

At least one some of the implementation of the systems, methods, apparatus, and/or code instructions described herein provide a technical solution to the technical problem of securing digital wallets by preventing access of users to the digital wallet. Conceptually, some implementations provide a personal wallet free architecture, where users are not provided with personal wallets, and do not interact with such personal wallets. Instead, a universal wallet that serves multiple users (i.e., cryptocurrency of multiple users is stored in the universal wallet) is provided. A management layer controls the universal wallet, and acts as an interface between user credentials of users and cryptocurrencies stored in the universal wallet, utilizing universal ID's for example, email, phone number, or any other universal ID and/or non universal ID. The management layer performs transactions of cryptocurrencies using the universal wallet based on user credentials rather than the users accessing private wallets. The management layer may provide rule based transactions, for example, for purchase of a bag of multiple cryptocurrencies (e.g., predefined ratios and/or amounts), and/or for purchase and/or sale of cryptocurrencies at defined events (e.g., after a decrease of 20%), optionally with a single selection (e.g., single click of a mouse, and/or single touch of a finger on a touch screen) of the bag and/or of the defined rule(s).

Users access cryptocurrencies stored in a universal wallet using user credentials (e.g., email, phone number, user name) that may be associated with a real user, rather than accessing the wallet using the wallet address. Direct access to the universal wallet by users may be prevented, and/or denied, preventing direct tampering with the contents of the universal wallet. Transactions of cryptocurrencies are not necessarily performed to another wallet of another user, but rather, according to the user credentials of another user. The transaction may be performed using the same universal wallet, by updating a registry that maps between user credentials and amount stored in the universal wallet. The removal of direct access to the wallets by the users prevents or reduces malicious activity arising from the anonymity inherent in the wallet addresses, since the user credentials are directly tied to a real user.

At least one some of the implementation of the systems, methods, apparatus, and/or code instructions described herein address the technical problem of cybersecurity, in particular, to providing security of digital wallets storing digital currency hosted by a server. Using existing methods, in which servers, such as digital coin exchanges, have access to wallets of users, a breach to the server by a malicious entity provides access to a large number of wallets from which the cryptocurrency may be stolen. For example, a hacker may access a million wallets of a digital coin exchange, and transfer funds stored by the wallets (e.g., equivalent to $50 million) into an anonymous wallet owned by the hacker.

At least one some of the implementation of the systems, methods, apparatus, and/or code instructions described herein address the technical problem of purchasing multiple types of cryptocurrencies. Using existing methods, each type of cryptocurrency requires a separate transaction issued to the exchange server and/or service site. For example, purchasing 4 coins of a certain amount (e.g., 30 Bitcoin, 10 Ethereum, 5 Dash, 5 Ripple coins) requires 4 transactions. The multiple transactions reduce the computational efficiency of the client terminal of the user issuing the transactions, the network that transfers the transactions, and the server(s) that execute the transactions, and/or remove the need for users to store and/or manage multiple personal wallet types required for different types of crypto currencies, as the universal wallet(s) store and/or manage different types of cryptocurrencies for multiple users without the user directly managing the universal wallet(s) themselves. For clarification, existing exchanges allow a user to buy various types of currencies (optionally cryptocurrencies) on the exchange—but it is different than at least some of the implementation of the systems, methods, apparatus, and/or code instructions described herein, as in the exchanges it is a “virtual position” on a digital asset” and not the ability to use cryptocurrency as “real money” to pay and/or buy as described herein. In contrast, at least one some of the implementation of the systems, methods, apparatus, and/or code instructions described herein improve user experience of multi-cryptocurrency transactions, and/or improve computational efficiency of client terminals and/or networks and/or servers, by providing a feature for purchase and/or sale of multi-cryptocurrency (e.g. multi-coin) coins with a single click. The feature offers pre-defined and/or defined on the fly bundles of various cryptocurrencies (e.g., coins), for example, a certain percentages and/or number of coins of each type. Alternatively, users may create their own bundles and/or mix and match bundles.

At least one some of the implementation of the systems, methods, apparatus, and/or code instructions described herein address the technical problem of complexity of architectures based on personal digital wallets. Such architecture, as currently defined, is complex, requiring complex technical processing for activating such wallets, buying digital currency using the wallet, storing the digital currency in the wallet. Moreover, the anonymous design of the architecture is difficult for non-technical users to use. In contrast, at least one some of the implementation of the systems, methods, apparatus, and/or code instructions described herein does not use client side personal wallets, but replaces the client side personal wallet with server side temporary wallets and server side universal wallets. User may perform cryptocurrency transactions (e.g., send, receive, buy, sell, add, withdraw) using user credentials (e.g., user ID, email address, phone number), with improved user experience due to reduced complexity.

At least one some of the implementation of the systems, methods, apparatus, and/or code instructions described herein improve the technical field of cybersecurity, in particular, cybersecurity of cryptocurrencies. Existing architectures for storing and/or trading cryptocurrencies are insecure, not only at the server/exchange security level, but also at the user security level, such as actions required to be performed by the user to secure cryptocurrency coins owned by the user. At least one some of the implementation of the systems, methods, apparatus, and/or code instructions described herein remove existing client side personal wallets which are managed and stored by users, and operate without such personal wallets. The removal of the personal wallet improves user experience of performing cryptocurrency transactions since users do not need to worry about security their personal wallet client side. Access of malicious entities to the personal wallet is nonexistent due to the removal of the persona wallet.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

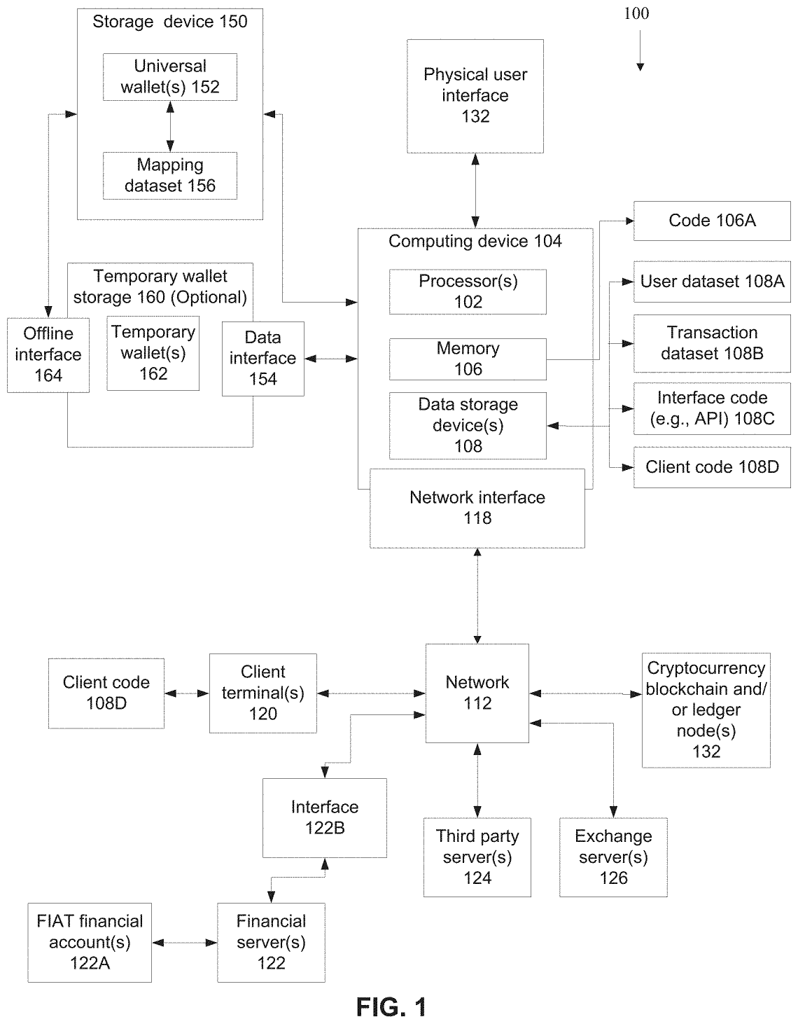

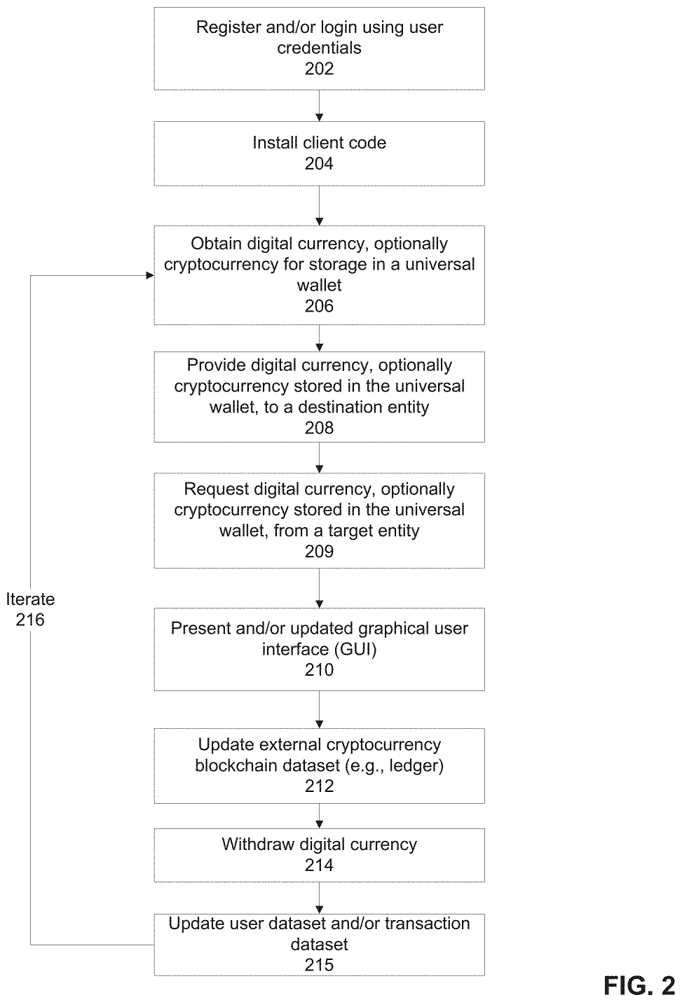

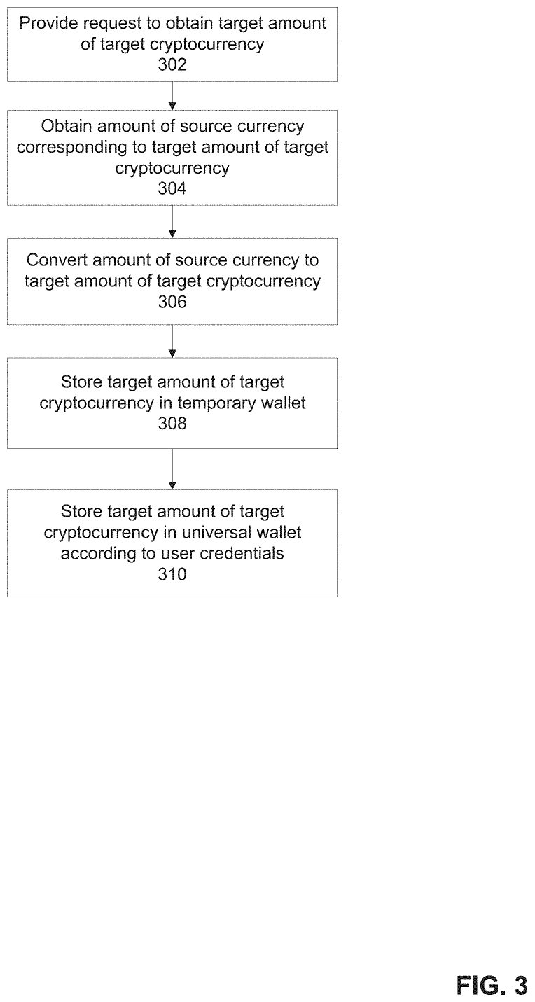

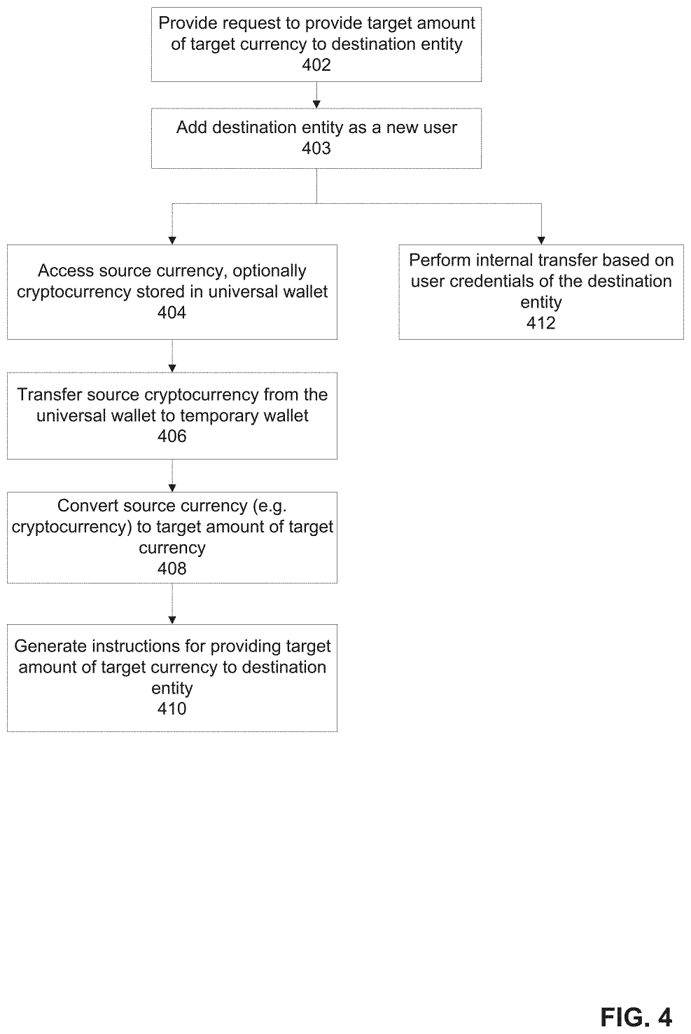

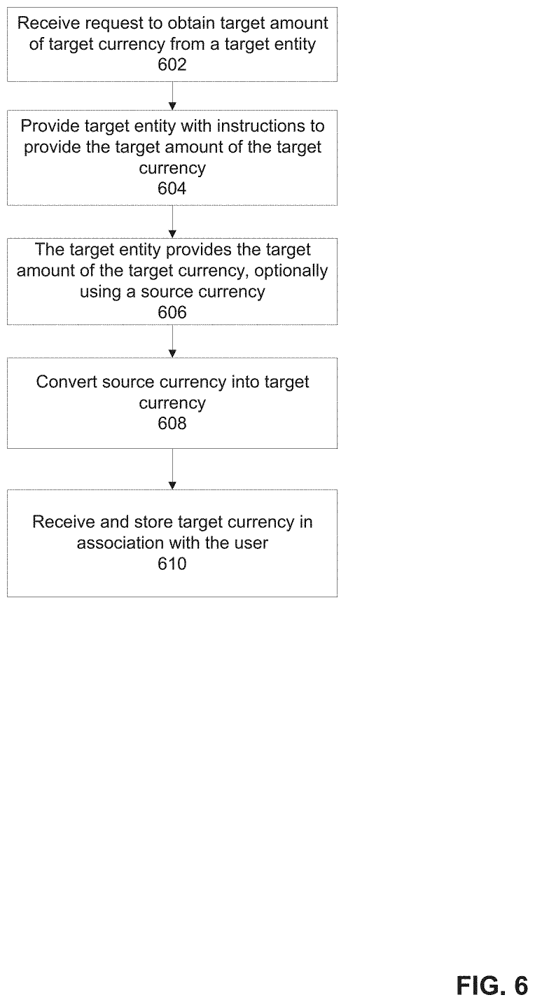

Reference is now made to FIG. 1, which is a block diagram of components of a system 100 for performing transactions using cryptocurrency stored in a universal wallet that stores cryptocurrency for multiple users according to corresponding user credentials, in accordance with some embodiments of the present invention. Reference is also made to FIG. 2, which is a flowchart of a high level process for performing transactions of digital currency (optionally at least including cryptocurrency) stored in a universal wallet, in accordance with some embodiments of the present invention. Reference is also made to FIG. 3, which is a flowchart of a process for obtaining (e.g., withdrawing) digital currency (optionally at least including cryptocurrency) stored and/or for storing in a universal wallet, in accordance with some embodiments of the present invention. Reference is also made to FIG. 4, which is a flowchart of a process for providing (e.g., transferring, paying, making a purchase) digital currency (optionally at least including cryptocurrency) stored in a universal wallet, in accordance with some embodiments of the present invention. Reference is also made to FIG. 6, which is a flowchart of an exemplary process for requesting to be provided with a target amount of a target currency by another user, in accordance with some embodiments of the present invention. Components of system 100 may implement the acts of the methods described with reference to FIGS. 2-4, FIGS. 5A-5T, and FIG. 6 by code instructions stored in a memory executed by one or more hardware processors of one or more devices, for example, by hardware processor(s) of a computing device 104 executing code instructions (e.g., code 106A) stored in a memory 106 (also referred to as a program store).

System 100 provides a personal wallet-free architecture, using the universal digital wallets 152 for storing cryptocurrency for user of client terminals 120. Computing device 104 stores cryptocurrency for users in the universal wallets 152 without necessarily requiring personal wallets for the user, as described herein.

In some implementations, a data storage device 150 (optionally a cold storage device) may store one or more universal digital wallets 152 for storing at least one cryptocurrency. Each universal wallet stores one type of cryptocurrency. There may be multiple universal wallets for storage of different types of cryptocurrency, optionally one or more universal wallet for each type of cryptocurrency. Exemplary cryptocurrencies include Bitcoin, Ethereum, NEO, and Ripple (XRP). Universal digital wallets 152 may store cryptocurrency for multiple different clients, as described herein. Storage device 150 may be implemented as, for example, a memory, a local hard-drive, virtual storage, a removable storage unit, an optical disk, a storage device, and/or as a remote server and/or computing cloud (e.g., accessed using a network connection).

In another implementation, universal wallet(s) 152 are stored on a non-cold storage device, for example, when other security processes are implemented. In such an implementation, temporary wallets(s) 162 as described herein may not necessarily be implemented.

Data interface 154 may be implemented as, for example one or more of, a data (e.g., network) interface card, a wireless interface to connect to a wireless connection (e.g., network), a physical interface for connecting to a cable for data (e.g., network) connectivity, a virtual interface implemented in software, data (e.g., network) communication software providing higher layers of data (e.g., network) connectivity, and/or other implementations.

A mapping dataset 156 maps between user credentials (e.g., user IDs) and locations within universal wallet(s) 152 and/or amount of cryptocurrencies stored within universal wallet(s) 152. For example, mapping dataset 156 may be implemented as an array of pointers that point from a data structure storing user IDs to memory location of the universal wallet(s) 152, where each memory location stores the amount of cryptocurrency assigned according to the respective user ID.

Mapping dataset 156 is connected to universal wallet(s) 152 via a secure offline connection that is not necessarily directly connected to external computing device(s) and/or networks.

Mapping dataset 156 may be synchronized with user dataset 108A, which may be stored in memory 106 of computing device 104. Mapping dataset 156 may be stored offline, and user dataset 108A may be stored online. Users may access user dataset 108A to determine balances of cryptocurrencies stored in universal wallet(s) 152, as described herein.

Mapping dataset 156 may be stored on storage device 150. In some implementations, storage device 150 storing universal wallet(s) 152 is implemented without temporary wallet(s) 162 and/or temporary wallet storage 160. Computing device 104 may access storage device 150 and/or universal wallet(s) 152, as described herein. Alternatively, in other implementations, storage device 150 storing universal wallet(s) 152 is implemented as a cold storage device 150 in association with temporary wallet(s) 162 and/or temporary wallet storage 160. Access by computing device 104 to universal wallet(s) 152 is performed via temporary wallet(s) 162, as described herein.

Optionally, temporary digital wallet storage device 160 stores one or more temporary digital wallets 162 for storing at least one cryptocurrency and/or at least one FIAT currency. Temporary digital wallets 162 are created for each transaction and are deactivated (e.g., reset to zero value for re-use, destroyed, deleted), as described herein. Temporary digital wallet storage device 160 may be implemented as, for example, a memory, a local hard-drive, virtual storage, a removable storage unit, an optical disk, a storage device, and/or as a remote server and/or computing cloud (e.g., accessed using a network connection).

Optionally, temporary digital wallet storage device 160 includes a data interface 154 that provides data communication with external computing devices and/or a network, optionally with computing device 104. Data interface 154 is designed to temporarily connect to the external computing devices and/or the network and/or computing device 104 (e.g., to provide transfer of cryptocurrency into and/or out of temporary digital wallets 160, as described herein). Data interface 154 is designed to disconnect from the external computing devices and/or network and/or computing device 104 when temporary wallets 160 are synchronized with universal wallets 152 and/or mapping dataset 156. The disconnection provides additional security by preventing or reducing risk of malicious activity by externally located malicious entities, as described herein. When data interface 154 is disconnected from external computing devices and/or network and/or computing device 104, an offline connection may be established via an offline interface 164 with storage device 150 for transferring data during the synchronization process.

It is noted that is some implementations, temporary digital wallet storage device 160 and storage device 150 are implemented as a single data storage device.

Temporary wallet storage device 160 may be associated with computing device 104. Computing device 104 may activate and disconnect the connection to temporary wallet storage device 160, optionally via data interface 154. Synchronization between temporary digital wallets 160 and universal wallet 152 may be performed when the connection is disconnected and off-line, as described herein. Disconnection of the data connection provides security for temporary wallets 160 and/or universal wallets 152, by preventing or reducing access to temporary wallets 160 universal wallets 152 by external malicious entities, as described herein. Temporary wallets 160 may be accessed for deposit and/or withdraw of cryptocurrency by computing device 104 when the connection is active.

Storage device 150 may be associated with computing device 104.

Computing device 104 may be implemented as, for example one or more and/or combination of: a group of connected devices, a client terminal, a server, a virtual server, a computing cloud, a virtual machine, a desktop computer, a thin client, a network node, a network server executing code of a smart contract stored on a blockchain, a virtual reality device presenting a virtual reality interface, an augmented reality device presenting an augmented reality interface, and/or a mobile device (e.g., a Smartphone, a Tablet computer, a laptop computer, a wearable computer, glasses computer, and a watch computer).

Hardware processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-4 and 6 when executed by hardware processor(s) 102.

Computing device 104 may include data storage device(s) 108 for storing data. Data storage device(s) 108 may be implemented as, for example, a memory, a local hard-drive, virtual storage, a removable storage unit, an optical disk, a storage device, and/or as a remote server and/or computing cloud (e.g., accessed using a network connection). Data storage device 108 may store one or more of the following:

* User dataset 108A that stores records of users accessing code 106A for buying, selling, and/or transferring digital currency (e.g., FIAT and/or cryptocurrency). User dataset 108A may store user credentials of users for accessing code 106A, for example, user ID, user names, phone number, email, and/or other identification code.

* Transaction dataset 108B that stores a history of transactions implemented by users, for example, buying, selling, and/or transferring digital currency.

* Interface code 108C, for example, an application programming interface (API). Interface code 108C includes instructions for interfacing with external computing devices and/or servers, for example, with financial server for transferring FIAT, with exchange servers for exchanging cryptocurrencies and/or FIAT, and/or third party servers for providing an interface for transfer of digital currencies between users and the third party. Interface code 108C may include instructions to obtain the best price by comparing multiple exchange servers.

* Client code 108D, that may be provided to client terminals for local installation thereon, for example, as an add-on to a web browser to enable payment using cryptocurrencies at websites accepting FIAT, as an application for installation on a mobile device, and/or as an interface accessed by other locally installed code. The interface may be implemented, as, for example, API, software development kit (SDK), functions and/or libraries and/or add-ons added to existing applications executing on client terminal(s), an application for download and execution on client terminal that communicates with the computing device, function and/or interface calls to code 106A executed by computing device 104, and/or a remote access section executing on a website hosted by computing device 104 accessed via a web browser executing on client terminal(s).

It is noted that data stored by data storage device 108 may be loaded into memory 106 for execution by processor(s) 102.

Computing device 104 may include a network interface 118 for connecting to a network 112, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 112 may be implemented as, for example, the internet, a local area network, a virtual network, a wireless network, a cellular network, a local bus, a point to point link (e.g., wired), and/or combinations of the aforementioned.

Computing device 104 may connected with one or more of the following via network 112:

* Client terminal(s) 120. Client terminal(s) 120 are used by respective users for accessing code 106A on computing device 104 for performing transactions (e.g., buy, sell, trade, transfer) using digital currency (i.e., cryptocurrency and/or FIAT). Client terminals 120 may access code 106A via locally installed client code 108C, for example, as an add-on to a web browser, as an application installed on a mobile device, and/or as an interface added to other applications. Client terminals 120 may be implemented as, for example, as a desktop computer, a server, a virtual server, a network server, a web server, a wearable computer, a glasses computer, a virtual reality device, an augmented reality device, a virtual machine, a thin client, and a mobile device.

Optionally, client terminal(s) 120 is implemented as an internet of things (IoT) device, for example, as logic of an IoT bot. The IoT device may communicate with computing device 104 in response to a trigger from one or more sensors that may sense the external environment. The IoT device may automatically perform actions, for example, providing currency, obtaining currency, and/or making purchases using cryptocurrency, as described herein. For example, client terminal 120 is implemented as logic of an IoT device installed in a cold water dispenser with a sensor to detect when a filter requires changing. The IoT device in the cold water dispenser may trigger automatic purchase of a replacement filter using cryptocurrency of a user when the sensor detects that the filter needs to be changed.

* Financial server 122. FIAT may be stored by financial server 120, for example, in bank accounts and/or credit cards. FIAT may be deposited and/or withdrawn via financial server 120, for example, via interface 108C of computing device 104, as described herein.

Optionally, FIAT financial accounts 122A hosted by financial server 122 are linked to the universal wallet(s) managed by the computing device, via interface 122B. Interface 122B may be implemented as, for example, a server to server interface (i.e., connecting server 122 to computing device 104), or a standalone server that is provided with enhanced functionality (i.e., server 122 is enhanced with features of computing device 104). Interface 122B may include client code of computing device r04, as described herein. Interface 122B may be implemented as a while label solution (e.g., hosted by computing device 104, or as a standalone solution within financial sever 122 infrastructure), the provides the FIAT financial entity (e.g., bank, financial instrument trading platform, credit card company) the ability to enhance FIAT financial accounts with cryptocurrency features, as described herein. A GUI (which may be presented on a screen of client terminal 120 accessing FIAT financial account 122A), in addition to the existing FIAT account features, provides cryptocurrency features for cryptocurrency stored in the universal wallet via a single common platform. The GUI, within a single presented interface, provides icons for performing transactions using the available cryptocurrencies and/or available FIAT currencies, for example, purchase cryptocurrency using available FIAT (i.e., by conversion thereof), provide FIAT and/or cryptocurrency to a target entity, receiving FIAT and/or cryptocurrency from the target entity, and/or buy items from a website accepting only FIAT using cryptocurrency, as described herein.

* Third party server 124, for example, a server hosting an ecommerce website, an online store, a gambling website, and/or other websites for financial transactions using digital currency. Users of code 106A may interact with third party server 124 using a different digital currency, which is converted by interface 108C of computing device 104. For example, a user may purchase a book at an online book store, and pay using a cryptocurrency. The cryptocurrency is converted into FIAT (e.g., US dollar) and provided as payment to the online bookstore.

* Exchange server(s) 126, for exchanging cryptocurrencies and/or FIAT for example, via interface 108C of computing device 104, as described herein.

* Cryptocurrency blockchain and/or ledger node(s) 132. Nodes 132 store copies of the cryptocurrency blockchain and/or ledger that store a history of transactions of the cryptocurrency. Nodes 132 may be implemented using standard processes and/or formats, for example, as defined for Bitcoin, Ethereum, and/or other cryptocurrencies. Computing device 104 acts as a management layer for interfacing between universal wallet(s) 152 and nodes 132. Optionally, the wallet address (e.g., private key, public key, network address) of universal wallet(s) 152 is provided to nodes 132 for recording of transactions of cryptocurrencies that occur between universal wallet(s) 152 and other external entities and/or external wallets. It is noted that as described herein, the interface and/or interaction with nodes 132 is transparent to users, based on the use of user credentials for accessing cryptocurrencies stores in universal wallet(s) 152 rather than the users accessing private wallets. As described herein, users do not directly access universal wallet(s) 152 and/or do not necessarily access other private wallets, and/or transactions between users may be performed using the same universal wallet(s) 152 and/or recorded in mapping dataset 156 rather than on the blockchain of nodes 132.

A malicious device (e.g., computing device used by a hacker) is unable to access universal wallets 152 via network 112 and/or computing device 104. Funds stored on universal wallets 152 are secure. At most, malicious device may be able to gain temporary access to temporary wallet(s) 160 which may not necessarily be active. Since temporary wallet(s) 160 are temporarily accessible and/or exist for a temporary amount of time, timing access to temporary wallet(s) 160 posses an addition level of security, making it more difficult for malicious device to access. Moreover, temporary wallet(s) 160 may not necessarily have any funds stored thereon. Moreover, even when temporary wallet(s) 160 store funds, the amount of funds may be limited to funds of a single transaction, and/or may be capped at a predefined value, for example $5000 (or equivalence in other digital currency), $10000 (or equivalence in other digital currency), or other value.

Computing device 104 and/or client terminal(s) 120 include and/or are in communication with one or more physical user interfaces 132 that include a display and/or a mechanism for a user to enter data, for example, to display a graphical user interface (GUI) indicative of the performed financial transaction, and/or for the user to enter details for the digital currency transaction. Exemplary physical user interfaces 132 include, for example, one or more of, a touchscreen, a display, gesture activation devices, a keyboard, a mouse, and voice activated software using speakers and microphone.

Referring now back to FIG. 2, at 202, a user registers and/or logs in to the computing device. The user may log in via the client terminal over the network. The user registration and/or login is performed with user credential that may be selected by the user and/or are tied to the identity of the user, for example, one or more of: username, password, email, and telephone number. The amount of digital currency (optionally at least cryptocurrency) stored in the universal wallet for each user is mapped to the user credentials of the user, optionally stored in the user dataset and/or mapping dataset.

Optionally, the user associated with the user credentials is denied direct access to the universal wallet for direct deposit and/or withdrawal of cryptocurrency. Users may not be aware and/or prevented from gaining access to the keys (e.g., hash, private key, and/or public key) and/or network address of the universal wallet. The deposit and/or withdrawal of cryptocurrency to the universal wallet is provided by the computing device, optionally via the GUI, as described herein.

Optionally, the universal wallet is used for multiple users, and private wallets for each user are not required.

The universal wallet is a server side wallet. Client side wallets of user (e.g., private wallets) are not required.

Optionally, a single universal wallet stores cryptocurrency for multiple users according to corresponding user credentials. It is noted that there may be multiple universal wallets, for example, different wallets for different types of cryptocurrencies. Each universal wallet stores cryptocurrency for multiple users. It is noted that there may be multiple universal wallets, for example, where there are a large number of users, each wallet store cryptocurrency for a sub-set of users. For example, for 100,000 users, there may be 100 wallets, each storing cryptocurrency for 1000 users.

Optionally, an amount of a same type of cryptocurrency of user(s) is divided and stored by multiple universal wallets designed to store the same type of cryptocurrency. The division may be equal for each universal wallet, and/or based on the capacity available for each universal wallet, and/or based on other division methods. The distribution of the cryptocurrency across multiple universal wallets adds another layer of security, for example, breach of a single universal wallet only affects a portion of the funds of the user. For example, the user has $100,000 worth of Bitcoin divided and stored across 1000 universal wallets, for example, $100 worth of Bitcoin in each wallet. Breach (or other failure) of a single wallet affects only $100 of the user, reducing overall risk. It is noted that the architectural layer described herein automatically manages the multiple wallets for the user, removing the requirement for the user to manage each wallet independently as would otherwise be required.

Optionally, users may link personal wallets to the computing device, for example, registering the address of the personal wallets to the user dataset. Users with personal wallets may transfer cryptocurrency between the personal wallet and the universal wallet. The personal wallets may be added after performing, for example know your customer (KYC) procedures and/or anti money laundering (AML) procedures.

At 204, client code may be installed on client terminal. The client code may be downloaded from the computing device over the network for local installation on the client terminal. The client code may be implemented as, for example, an add-on to a web browser stored and executed by the client terminal (e.g., desktop computer, laptop computer) and/or as an application stored an executed by a mobile device implementation of the client terminal (e.g., smartphone, tablet computer, watch computer, glasses computer). The add-on to the web browser may be implemented as extension code.

The client code may include code for interfacing with a website hosted by a third party server (e.g., online retailer, ecommerce) rendered by the browser, and optionally inserting additional multimedia objects (e.g., icons, windows) into the rendered website, for example, to enable purchase of items from the website using cryptocurrency where the website only accepts FIAT currency. The client code may include instructions for setting a target amount (i.e. the amount to provide) and a target currency (i.e., the currency accepted by the website) for the destination entity according to the website, for example, based on an analysis of the website the code determines the cost of items available for purchase on the website and the currency accepted by the website for payment for the items. The client code may include instructions for transmitting a request to the computing device, for transferring the target amount of the target currency to the website according to the corresponding value of a selected cryptocurrency, for example, for purchase of an item on the ecommerce website using cryptocurrency (e.g., Bitcoin) instead of FIAT currency (e.g., US dollars).

The add-on may be implemented, for example, as a selection object (e.g., box for clicking) that states “pay with Bitcoin” (or other cryptocurrency. The selection object may be rendered into the website for presented item(s), for checkout(s).

The add-on may be implemented as a single click selection to enable using a selected and/or predefined cryptocurrency for payment in place of the FIAT currency (or other non-cryptocurrency). For example, upon selection of the selection object, the corresponding amount of the cryptocurrency is deduced from the account of the user and used to pay for the item in the FIAT currency, as described herein.

In some implementations, the client code may be installed by the website, for example, for providing a mechanism for users to pay with cryptocurrencies. For example the client code may include a software interface, such as software development kit (SDK), for implementation by the code of the website. However, it is noted that installation of the client code by the website is not necessarily required when the client code is added-on to the browser and provides another layer over the website without installation of the client code being required for the code of the website.

In implementations in which the add-on cannot be added to the browser, for example, when executing on a browser of a mobile device, the client code may be implemented, for example, by a dedicated website (e.g., hosted by the computing device and/or an associated serer) and/or by the user adding the URL of the ecommerce site of the end of the URL of the dedicated website. The dedicated website may link to websites of online merchants, with the option to purchase using cryptocurrency appearing like in a desktop. When the URL of the ecommerce website added is added to the URL of the dedicated website, the ecommerce website may open in the mobile browser with the selection object enabled.

In another implementation, the client code may be downloaded as an app with preloaded ecommerce websites having the selection objected added. Via the app, the user may browse and shop at the ecommerce websites, while provided with the option to pay using cryptocurrencies.

In another implementation, the client code may be installed by a financial server storing FIAT currency accounts of the user, for example, a bank server of a bank storing bank accounts of users. The client code may be executed within an interface of the financial server used by the user to access the financial account, for example, within a GUI executing on a client terminal of a user that accesses the bank account stored by the financial server. The features described herein (e.g., obtaining currency, providing currency) may be executed from within the GUI accessing the bank account stored by the financial server, optionally via a software interface (e.g., API) of the computing device. The user may be automatically connected for example, via a server-to-server API or client to the financial server of a financial institution and/or bank. The interface connects the user credentials, indications of user identity (e.g., user ID number), and/or FIAT currency stored by the financial server to the user dataset and/or universal wallet. The client code, when executed by the financial server, enhances the GUI of the financial server during access of the bank account, to provide additional features of the computing device, for example, direct conversion of the FIAT funds in the bank account to cryptocurrency (e.g., without requiring wire transfer, know your customer (KYC) procedures, anti money laundering (AML) procedures, and/or transfer via credit card). The client code may instruct the GUI to present an object, for example, an icon that when pressed presents within the GUI (e.g., beside the FIAT currency in the bank account) the amount of each cryptocurrency stored in the universal wall and/or cryptocurrency value of the FIAT currency stored in the bank account. The client code executed by the financial server may spare the user from separately accessing the computing device and entering login data, by automatically identifying the user according to the access to the bank account. The user credentials may be provided from the financial server to the computing device via the interface based on the user accessing the bank account.

At 206, digital currency (optionally at least cryptocurrency) is obtained. Optionally, cryptocurrency currency obtained by conversion of FIAT currency is stored in the universal wallet. FIAT currency (e.g.,

Additional details of an exemplary process for obtaining cryptocurrency for storage in the universal wallet is described with reference to FIG. 3.

At 208, cryptocurrency stored in the universal wallet (and/or other digital currency) is provided and/or transferred to a destination entity. For example, the cryptocurrency is transferred as payment to another entity, and/or provided as part of a purchase of an item to an online retailer. The destination entity may be, for example, another user not registered by computing device (i.e., not having user credentials stored in the user dataset and/or the mapping dataset), another user registered by computing device (i.e., having user credentials stored in the user dataset and/or the mapping dataset), and a website (e.g., ecommerce website accepting payment for purchase of items in FIAT currency for which the user wishes to pay using cryptocurrency).

It is noted that multiple target currencies and/or multiple source currencies may be selected, for example, via a single click, as described herein.

The term target amount of the target currency, as used herein, refers to the amount and the currency that is being provided to the destination entity. The target amount of the target currency may be converted from one or more cryptocurrencies stored in the universal wallet in association with the user credentials.

It is noted that the target amount of the target currency (which is converted from one or more cryptocurrencies stored in the universal wallet in association with the user credentials) is provided to the destination entity according to user credentials of the destination entity and the user credentials of the user. The target amount of the target currency provided based on user credentials is in contrast to other existing methods that are according to private wallet addresses of the destination entity and private wallet addresses of the private wallet used by a user.

Optionally, cryptocurrency stored in the universal wallet (and/or other digital currency) cannot be provided and/or transferred to a personal wallet. Optionally, transfer is performed, for example, by updating the user dataset and/or mapping dataset to reflect the transaction performed internally by the computing device (e.g., transfer of cryptocurrency stored by the universal wallet from one user to another). Such internal transfer of cryptocurrency may be performed by updating an internal transaction dataset, without necessarily updating an external cryptocurrency blockchain dataset (e.g., ledges). Internal transfer of cryptocurrency may be performed using the same universal wallet, by updating the internal user dataset and/or mapping dataset according to an indication that the amount of cryptocurrency stored in the universal wallet and associated with the user credentials of the user, is transferred to the user credentials of the destination entity, while remaining in the same universal wallet. Alternatively or additionally, transfer of cryptocurrency is performed by converting the cryptocurrency into FIAT currency, and transferring payment of the FIAT currency to a non-wallet data structure associated with the destination entity, for example, a credit card number, a bank account, and a FIAT currency account managed by a third party server.

Authentication processes may be implemented prior to transfer of digital currency to the destination entity.

Additional details of an exemplary process for providing cryptocurrency stored in the universal wallet is described with reference to FIG. 4.

At 209, the user may requested to be provided with a target currency (e.g., cryptocurrency and/or FIAT) by a target user credential. Additional details of an exemplary process for requesting cryptocurrency and/or FIAT is described with reference to FIG. 6.At 210, a GUI presented on a display of the client terminal is presented and/or updated to indicate a current balance of cryptocurrency stored in the universal wallet associated with the user credentials (and/or other digital currency). It is noted that act 210 may be implemented before acts 206 and/or 208 and/or after acts 206 and/or 208.

The GUI may be rendered and/or presented by client code.

The GUI may include fields and/or objects for user selection for performing cryptocurrency transactions, as described herein.

The client code may include instructions for presenting one or more of the following in the GUI:

* Selection of an option for payment using cryptocurrency instead of FIAT. Optionally, a manual user selection of execution of a request for transferring a target amount of a target currency to a website according to a corresponding cryptocurrency value. For example, an add-on to a tool bar of the web browser and/or an object (e.g., window) added to the rendered website that for selection thereof. Selection of the object triggers the process, for example, of paying for an item offered by the website using cryptocurrency in place of FIAT, optionally for websites that only accept FIAT, as described herein. The cryptocurrency used for payment may be selected by the user via the GUI when multiple cryptocurrencies are available (e.g., stored in the universal wallet). The manual user selection triggers payment of the target amount of the target currency to the website for purchase of item(s) using the corresponding value of the selected cryptocurrency. It is noted that the user may select to pay with multiple cryptocurrencies using a single click, for example, as described herein.

* A corresponding value in FIAT (or another digital currency) of one or more cryptocurrencies, for example, stored in the universal wallet in association with the user credentials of the user. The corresponding value may be obtained, for example, based on a currency exchange server, and/or real time market feeds.

* The GUI may be presented as an object (e.g., window) inserted into a website rendered by a browser, for example, a website of an online retailer offering items for purchase. The GUI (i.e., window inserted into the website) may include a button (and/or other object) for manual selection by the user for execution of a request (e.g., provide payment to the website in cryptocurrency in place of the FIAT accepted by the website).

* Selection of one or more cryptocurrencies (e.g., for providing, payment, transfer) from the available amount of cryptocurrencies stored in the universal wallet(s) and mapped to the user credentials. And/or selection of one or more cryptocurrencies for purchase, optionally according to available cryptocurrencies).

* Single click (e.g., with a mouse cursor, with a voice command spoken into speakers and processed by voice analysis code, with a finger touch) selection from a set of predefined rules defining multiple combinations of target cryptocurrencies for purchase and/or payment, as described herein. For example, one combination is to purchase cryptocurrencies in the ratio of 10:5:2 of cryptocurrencies of types A:B:C. Another example, is to purchase new offerings of cryptocurrencies in the percentages of: 50% of type X, 40% of type Y, and 10% of type Z. In another example, purchase of the top 3 cryptocurrencies that experienced the largest percentage increase in value over the past week. In yet another example, purchase the top cryptocurrency that experienced the largest percentage increase in value and purchase the top cryptocurrency that experienced the largest percentage decline in value over the last 3 days. In yet another example, one or more initial coin offerings (ICO) and/or security token sale/offering may be joined with the single click (or a few number of clicks). User data (e.g., credential) which are stored, optionally in the user dataset and/or universal wallet, are automatically extracted and provided for registration of the user for the ICO and/or security token offering. The registration and purchase of the ICO and/or security token is provided via the single click, in contrast to the user manually registering for each ICO and/or security token offering separately. Transfer of currency and/or conversion of source currency of the user for purchase of the ICO and/or security token is performed automatically, as described herein. The set of rules may be defined, for example, manually by the user, according to predefined configuration settings (e.g., set up by a central administration server), and/or automatically generated by code (e.g., randomly, based on an analysis of transaction patterns of other users, based on an analysis of historical transaction patterns of the same user).

* Presentation of a target amount for purchase. The purchase may be made according to a selected cryptocurrency, a selected FIAT currency, and/or according to the set of predefined rules defining multiple combinations of target cryptocurrencies for purchase and/or payment, optionally using a single click, as described herein. The target amount may be selected with a single click, for example, from a set of icons presenting different target amounts. For example, purchase $100 worth of Bitcoin, purchase $25 worth of a bundle of $15 worth of type X cryptocurrency, $10 worth of type Y cryptocurrency, and $5 worth of type Z cryptocurrency.

The selected combination (e.g., single cryptocurrency, combination of cryptocurrencies) is obtained by converting the amount of the source currency to the target amount of the target cryptocurrency in response to the single click.

At 212, an external cryptocurrency and/or ledger blockchain dataset stored by one or more network connected nodes may be updated based on the cryptocurrency transaction protocol(s). It is noted that the updating of the external cryptocurrency and/or ledger blockchain dataset may be transparent to the user(s). As described herein, the computing device provides a management layer that interfaces with the universal wallet and the external cryptocurrency and/or ledger blockchain dataset according to the user credentials, in contrast to other existing methods that require each user to use their own private wallet which is accessed by a private key (e.g., hash value).

Optionally, an address of the universal wallet is recorded in the ledger associated with the cryptocurrency (e.g., for each cryptocurrency) stored in the blockchain dataset that stores records of cryptocurrency transactions.

At 214, currency, optionally digital currency, is withdrawn. Digital currency, optionally cryptocurrency, may not necessarily be transferred to a personal wallet (owned by the same user or another user, and/or owned anonymously). In this manner, digital currency managed by the client terminal may be tracked, reducing and/or preventing the risk of a malicious entity transferring digital currency to an anonymous wallet which cannot be tracked. Digital currency may be withdrawn by transfer of the digital currency to an account managed by a server of a financial institution, for example, a credit card, a bank account, a debit account, and/or a third party financial services account. Cryptocurrency may be converted into non-cryptocurrency such as FIAT (as described herein) for transfer to the account.

The selected (optionally digital) currency may be converted to a target currency for withdrawing. For example, a cryptocurrency may be converted into a selected FIAT currency for withdrawal. The selection of the digital currency for withdrawal and/or the selection of the target currency may be performed, for example, via the GUI, for example, by the user selecting from multiple available digital currencies associated with the user credential, and/or by the user selecting from multiple available FIAT target currencies (e.g., according to the FIAT type of the financial accounts linked to the universal wallet of the user). Conversion from selected target currency to may be performed as described herein.

Optionally, cryptocurrency stored in the universal wallet is transferred to a temporary wallet, as described herein. The cryptocurrency in the temporary wallet may be obtained and converted into the source currency for transfer to the financial wallet of the user, as described herein.

An indication of accounts of the user may be stored, for example, in the user dataset and/or mapping dataset in association with the user credentials. A verification of authenticity of the accounts and/or verification that the account belongs to the user associated with the user entity may be performed prior to transfer of the digital currency in and/or out of the account.

At 215, the user dataset and/or transaction may be updated according to the performed transaction. The user dataset and/or transaction dataset may be updated to indicate the update amounts of one or more cryptocurrencies stored in the universal wallet(s) after the performed transactions, for the user and/or the target entity. For example, to indicate the new amount of cryptocurrency stored in the universal wallet for the user after obtaining cryptocurrency by conversion from a FIAT, after making a purchase using cryptocurrency, and/or after receiving cryptocurrency.

The user dataset is optionally synchronized with mapping dataset and/or based on the transaction dataset. The user dataset may be updated in response to a successful synchronization between the temporary wallet and the universal wallet.

The transaction dataset may be updated according to the synchronization process and/or according to the user dataset. The transaction dataset may store a record of the user associated with the user credentials obtaining the digital currency. It is noted that the external blockchain ledger may not necessarily be updated when the transaction of the user obtaining the digital currency is internal to the computing device.

The GUI may be updated accordingly to present the updated amount stored in the universal wallet belonging to the user (i.e., mapped to the user credentials of the user).

It is noted that the user dataset and/or transaction dataset may be implemented, for example, as part of act 212, for example, the external cryptocurrency ledger is updated together (e.g. simultaneously, near simultaneously, before, after) with the user dataset and/or transaction dataset. At 216, one or more of acts 206-215 may be iterated, for example, as the user performed multiple cryptocurrency (and/or other digital currency) transactions and/or as the GUI is updated accordingly.

Referring now back to FIG. 3, 302, a request is received for obtaining a target amount of one or more target cryptocurrencies. The request may be received from a client terminal over a network. The request may be entered by the user, for example, via the GUI and/or client code installed on the client terminal. The request may be for obtaining a target amount of the target cryptocurrency according to a corresponding value of a source currency, for example, obtaining $100 worth of Bitcoin.

At 304, an amount of a source currency corresponding to the target amount of the target cryptocurrency is obtained.

The source currency may be a non-cryptocurrency, optionally a FIAT currency, obtained from a financial server storing financial data of the user using the client terminal and associated with the user credentials. For example, a credit card server may be sent instructions for charging a credit card of the user, a debit card server may be sent instructions for charging a debit card of the user, and/or a bank server may be sent instructions for withdrawing from the bank account of the user.

Multiple target currencies may be purchased, optionally according to a single source currency with a single click that denotes a selected set of rules, as described herein. For example, buying a bundle of cryptocurrencies in a defined ratio.

One or more target currencies may be purchased based on a set of rules that define transactions, optionally according to a single click that denotes the selected transaction(s), as described herein. For example, purchase of the cryptocurrency that had the highest percentage gain over the last 48 hours.

At 306, the amount of the source currency is converted to the target amount of the target cryptocurrency.

The conversion may be performed by generating instructions for execution by an application programming interface (API) of an exchange server for obtaining the target amount of the at least one target cryptocurrency. The API of the exchange server may be accessed via the interface code executed by the computing device. Alternatively or additionally, the conversion may be performed internally by the computing device based on a stored inventory of different types of digital currencies. Such internal conversion (i.e., rather than using the exchange server) may be performed with relatively reduced or no conversion fees payable to perform the digital currency conversion.

Optionally, at 308, the target amount of the target cryptocurrency may be in a temporary wallet. The temporary wallet may be stored on a memory in communication with a network connection.

The storage of the cryptocurrency may be recorded in the transaction dataset, for example, as a mapping between the stored amount of cryptocurrency and user credentials of the user.

The temporary wallet may be an empty temporary wallet.

The temporary wallet may be a new temporary wallet created for each cryptocurrency transaction.

Optionally, the temporary wallet is re-used by multiple discrete users. The temporary wallet may be emptied and re-used for another user. Optionally, the empty temporary wallet is an existing temporary wallet used for temporary storage of cryptocurrency for the user, and reused for storage of cryptocurrency for another user when the temporarily stored cryptocurrency is removed, creating the empty temporary wallet.

The temporary wallet is disconnected from the network connection. When offline and disconnected from the network connection, the temporary wallet is synchronized with the universal wallet stored on a cold storage device which may be permanently disconnected from the network connection. The target amount of the one or more target cryptocurrencies stored in the temporary wallet is synchronized with the universal wallet stored in a data storage device disconnected from the network connection. The mapping dataset may be updated accordingly, for example, the amount of cryptocurrency mapped to the user credentials is updated according to the amount of cryptocurrency transferred from the temporary wallet to the universal wallet.

Optionally, the contents of the temporary wallet are removed to empty the temporary wallet. The transfer of the cryptocurrency from the temporary wallet to the universal wallet may empty the temporary wallet.

The temporary wallet may be re-connected to the network connection. Alternatively or additionally, the temporary wallet is deleted, and/or blocked from further access thereto. A new temporary wallet connected to the network connection may be created for use by the same user or by a new user, for storage of a new target amount of one or more new target cryptocurrencies. Alternatively, the empty temporary wallet is reused, as described herein.

At 310, the target amount of the target cryptocurrency is stored in the universal wallet according to the user credentials.

The universal wallet stores cryptocurrency for multiple users according to corresponding user credentials. The mapping dataset maps between amounts of cryptocurrency stored in the universal wallet and user credentials.

Referring now back to FIG. 4, 402, a request is received for providing a target amount of a target currency to a destination entity. The request may include a source currency of an amount corresponding to the target amount of the target currency.

The target currency may be selected by the user and/or the destination entity, for example via the GUI. The target currency may be a preset currency, for example, predefined by the user and/or according to system configuration.

The target currency may be a cryptocurrency and/or non-cryptocurrency such as a FIAT currency.

The request may be for providing the target amount of the target currency according to a corresponding value of one or more selected source cryptocurrencies, for example, transfer $100 worth of Bitcoin to johndoe@johndoe.com.

The request may be received from a client terminal over a network. The request may be entered by the user, for example, via the GUI and/or client code installed on the client terminal.

The destination entity may be a website, for example, an ecommerce website for purchase of an item, as described herein.

The destination entity may be another user, which may or not may be registered with the computing device. The another user is denoted by user credentials, for example, email and/or phone number.

The request may be provided, for example, transferring the target amount of the target currency, for paying the target entity, and/or for buying an item.

At 403, user credentials of the destination entity are registered and added as a new user when the destination entity is based on user credentials that are not registered with the computing device, for example, the user credentials of the destination entity are not stored in the user dataset storing mapping between multiple of user credentials and corresponding amounts of cryptocurrency stored in the universal wallet. In such a case, instructions are generated for transmitting a link to the user credentials of the destination entity, for example, in an email to the email address, and/or in a message to the phone number. When the link is clicked, a record may be created in the user dataset, for registration of the user credentials of the destination entity with the computing device. The registered destination entity may be provided with the target amount of the target currency according to the registered user credentials, by updating the user dataset and/or the mapping dataset, optionally according to a transaction record stored in the transaction dataset, for example, as described with reference to act 414.

Acts 404-410 relate to the case of where the target amount of the target currency is provided to a non-wallet data structure of the destination entity, for example, a bank account, a credit card, payment to a website, and/or payment via a third party server.

Act 412 relates to the case of where the target amount of the target currency is provided according to user credentials of the destination entity registered with the computing device, for example, stored in the user dataset.

At 404, the source currency, optionally cryptocurrency stored in the universal wallet, is accessed according to the user credentials.

Alternatively or additionally, cryptocurrency stored in an external private wallet may be accessed according to the public key, private key, hash, and/or address of the private wallet. For example, users may use cryptocurrency stored in their private wallets to make online payments at websites that accept FIAT currency, as described herein.

Optionally, at 406, the source cryptocurrency may be transferred from the universal wallet to a temporary wallet stored on a memory. The temporary wallet may be empty. The transfer to the temporary wallet may be performed by disconnecting the temporary wallet from a network connection. When offline and disconnected from the network connection, the amount of the source cryptocurrency corresponding to the target amount of the target currency is synchronized with the temporary wallet, optionally by transferring the cryptocurrency from the universal wallet to the temporary wallet. The universal wallet may be stored in a cold storage device disconnected from the network connection. The temporary wallet may be stored in a data storage device that may be connected to the network connection and disconnected from the network connection. The temporary wallet may be re-connected to the network connection.

The temporary wallet may be an empty temporary wallet.

The temporary wallet may be a new temporary wallet created for each cryptocurrency transaction.

Optionally, the temporary wallet is re-used by multiple discrete users. The temporary wallet may be emptied and re-used for another user. Optionally, the empty temporary wallet is an existing temporary wallet used for temporary storage of cryptocurrency for the user, and reused for storage of cryptocurrency for another user when the temporarily stored cryptocurrency is removed, creating the empty temporary wallet.

Optionally, the mapping database is stored on the cold data storage device disconnected from the network connection. The mapping data may be updated offline according to the synchronization of the temporary wallet and the universal wallet.

At 408, the source cryptocurrency may be converted to the target amount of the target currency.

The conversion may be performed by generating instructions for execution by an application programming interface (API) of an exchange server for obtaining the target amount of the at least one target cryptocurrency. The API of the exchange server may be accessed via the interface code executed by the computing device.

At 410, instructions for providing the target amount of the target currency to the destination entity are generated. The target amount of the target currency may be provided to the destination entity, according to the instructions.

Optionally, the target currency comprises a FIAT currency and/or other non-cryptographic currency, and the generated instructions include instructions for depositing the target amount of the target currency into a financial account of the destination entity stored by a financial server, for example, to a credit card number of a credit card managed by a credit card server, to a bank account number of a bank account hosted by a bank server, and/or to an account hosted by a third party financial server.

The user dataset and/or transaction dataset may be updated in response to an indication of a successful transfer of the target amount of the target currency to the destination entity.

At 412, transfer may be made internally to computing device, without necessarily updating the external blockchain dataset storing the ledger for the cryptocurrency. Such transfer may be made internally when the user credentials of the user and the user credentials of the destination entity are both registered with the computing device and optionally are mapped to universal wallet(s) managed by the computing device, optionally the same universal wallet.

Such transaction may be performed quickly and/or securely, since updating of the external blockchain dataset of the ledge of the cryptocurrency is not necessarily required. For example, transactions may be substantially immediate (e.g., without noticeable delay to the users). Transactions may be performed without time delays due to mining operations defined by blockchain cryptocurrency protocols. Transactions may be performed without incurring volatility in currency fluctuations arising due to time delays that would others be incurred due to processing based on blockchain cryptocurrency protocols.

The transaction may be performed by updating the user dataset, to indicate that the target amount of cryptocurrency stored in the universal wallet owned by the user credentials is now transferred to an owned by the user credentials of the destination entity.

The transaction may be recorded in the transaction dataset of the computing device. The transaction dataset may be stored in a memory in communication with a network connection. The transaction dataset may be disconnected from the network connection. When offline and disconnected from the network connection, the transaction dataset may be synchronized with the mapping dataset and/or the universal wallet. The mapping dataset and/or the universal wallet may be stored on a cold data storage device disconnected from the network connection. The mapping dataset stores a mapping between each of the user credentials and the amount of each of the cryptocurrencies stored in the universal wallet. The user dataset may be updated according to the transaction dataset and/or in response to the synchronization.

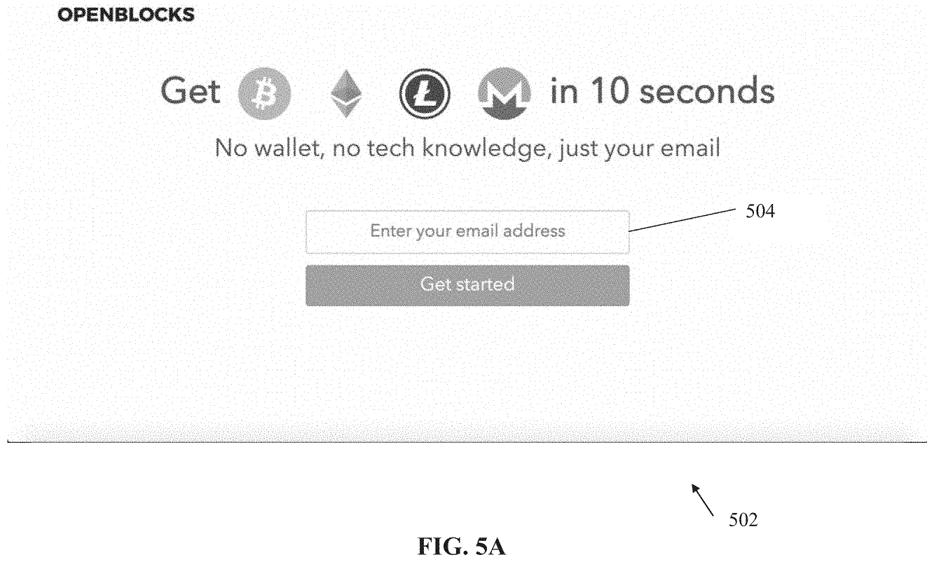

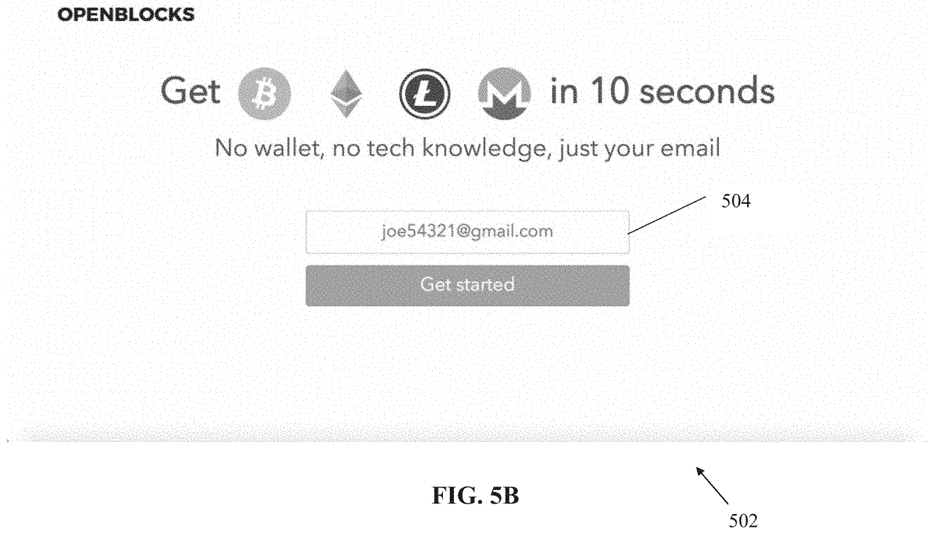

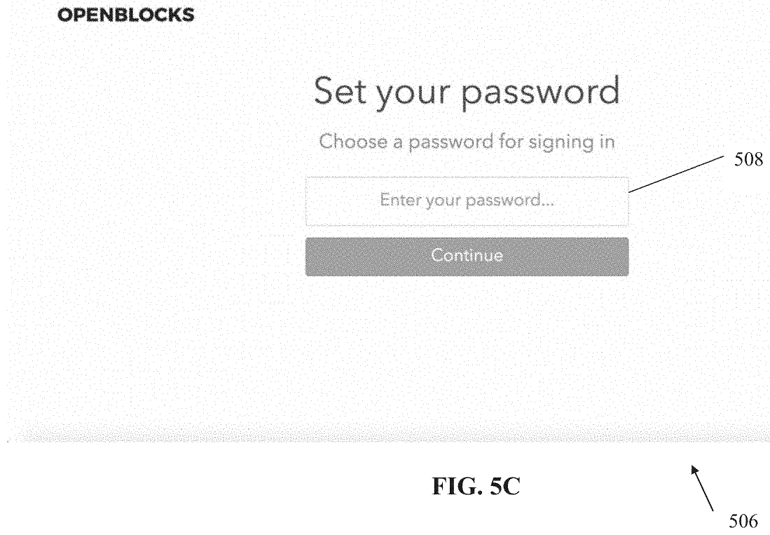

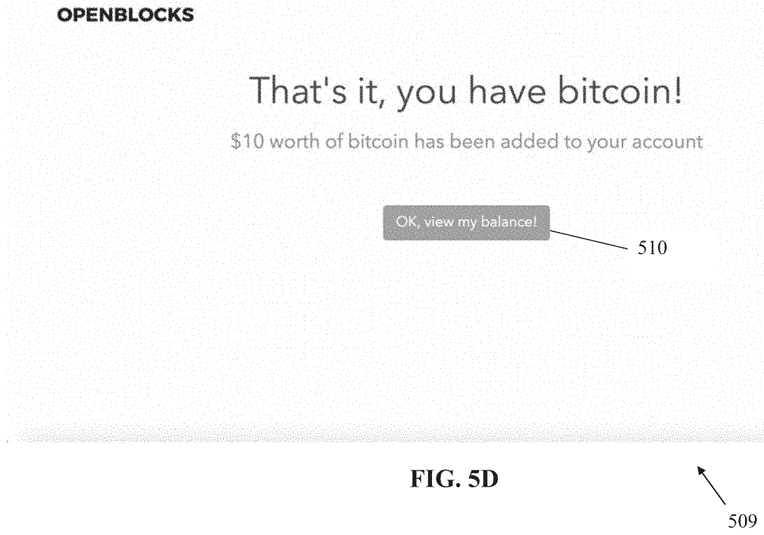

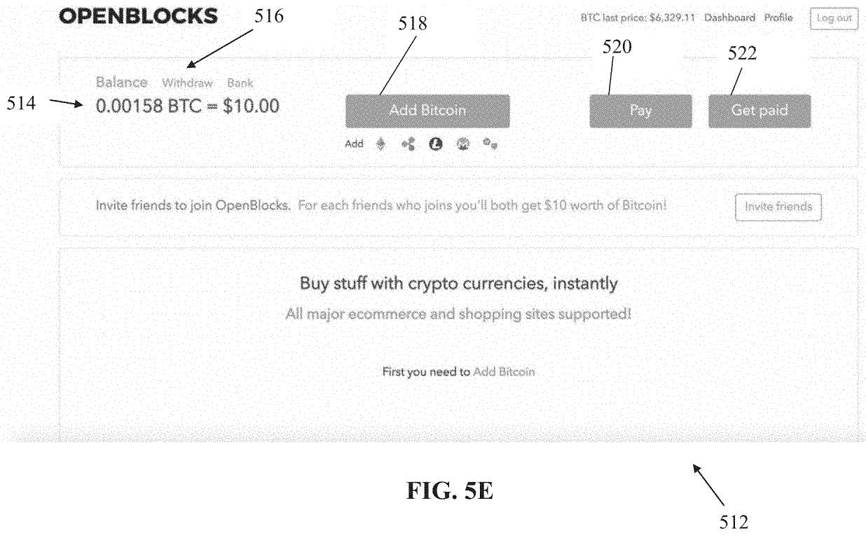

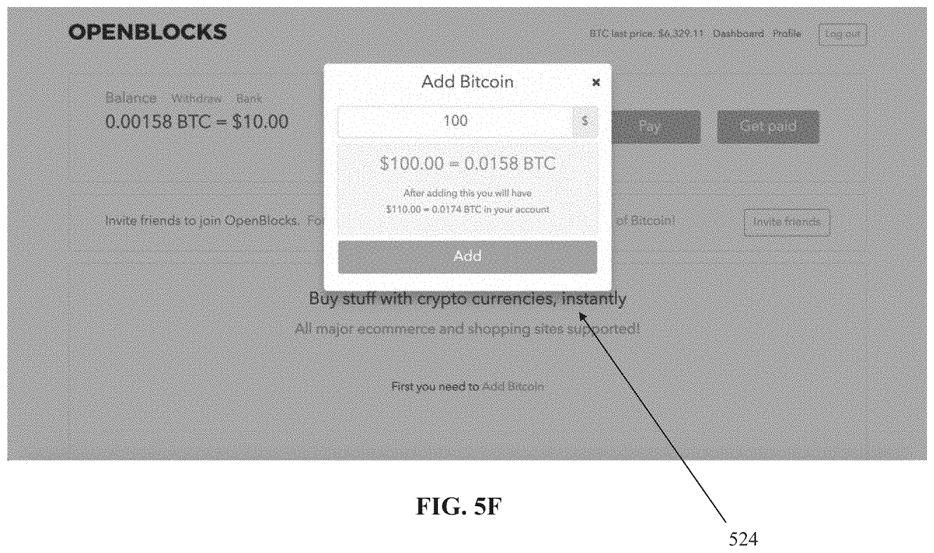

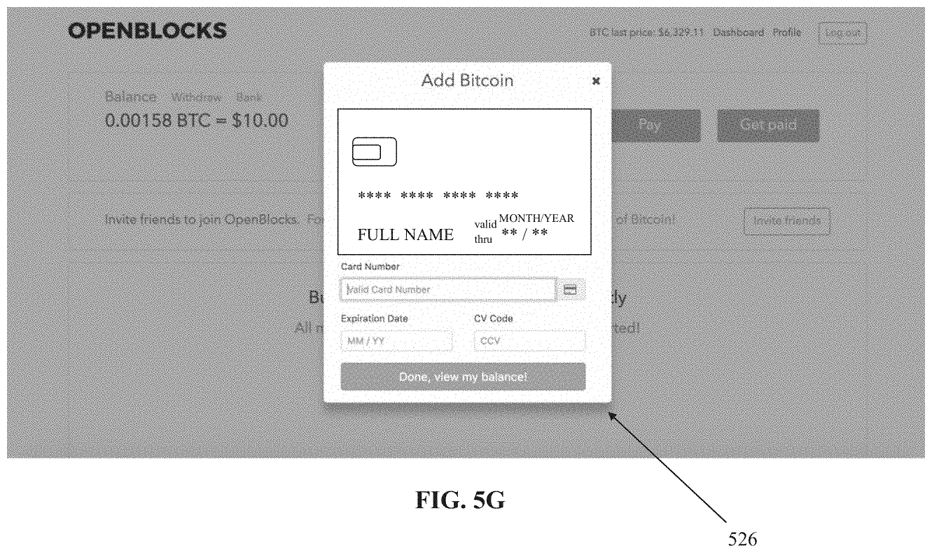

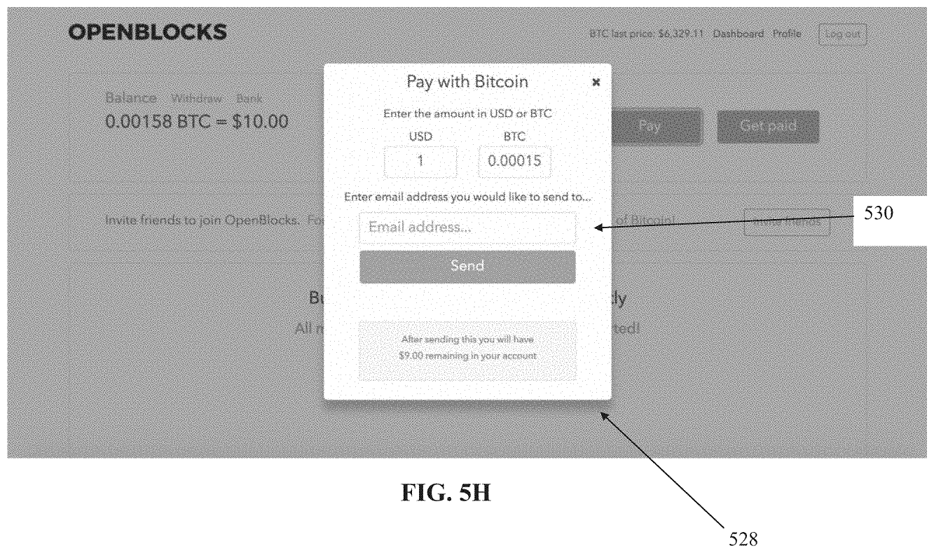

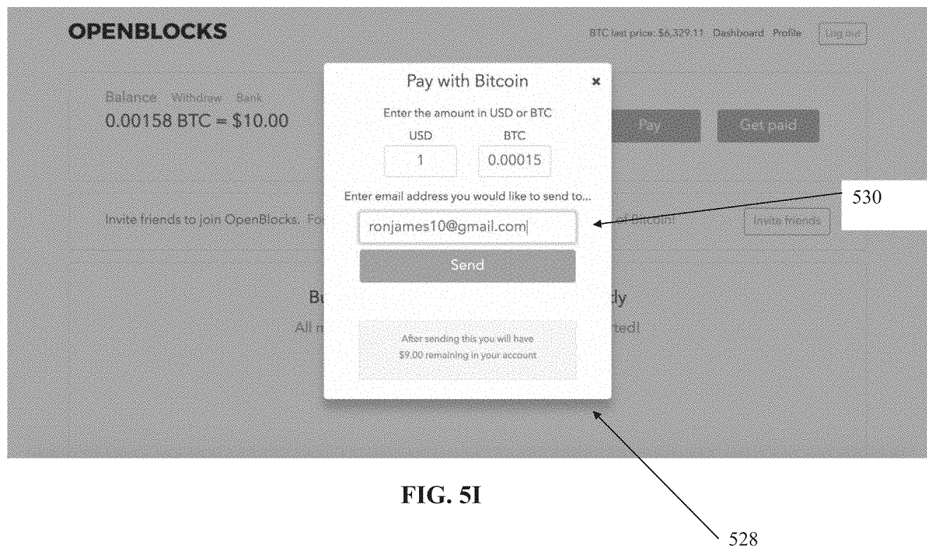

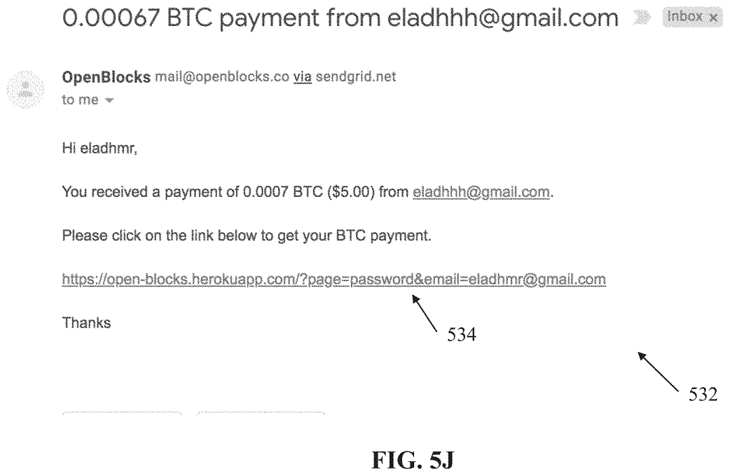

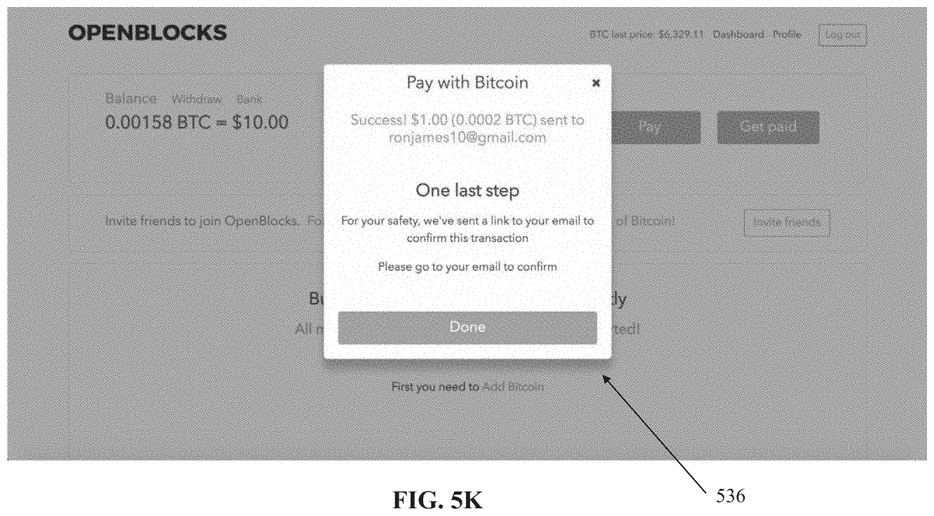

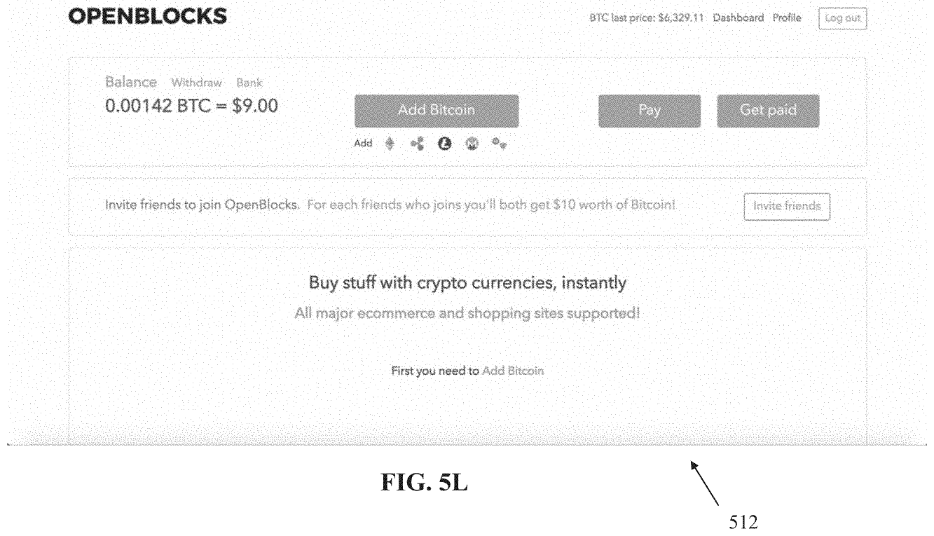

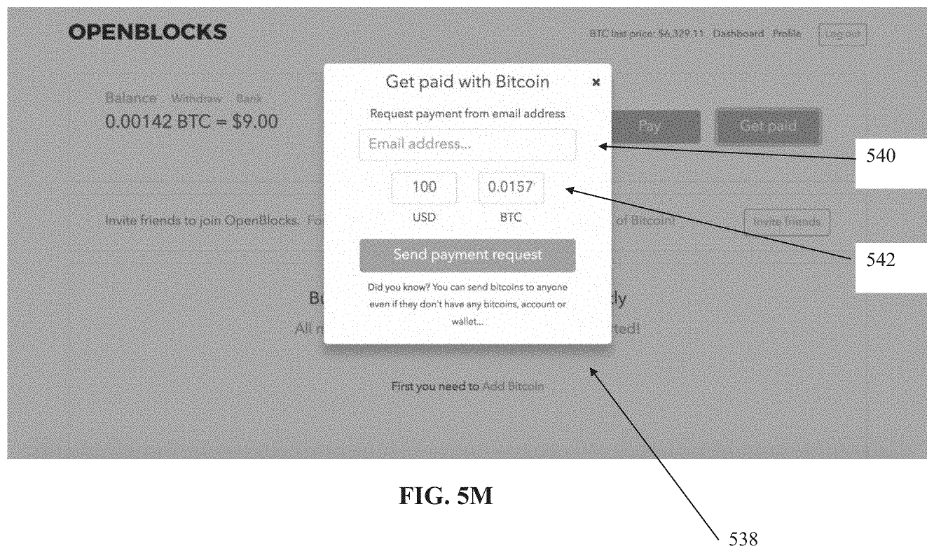

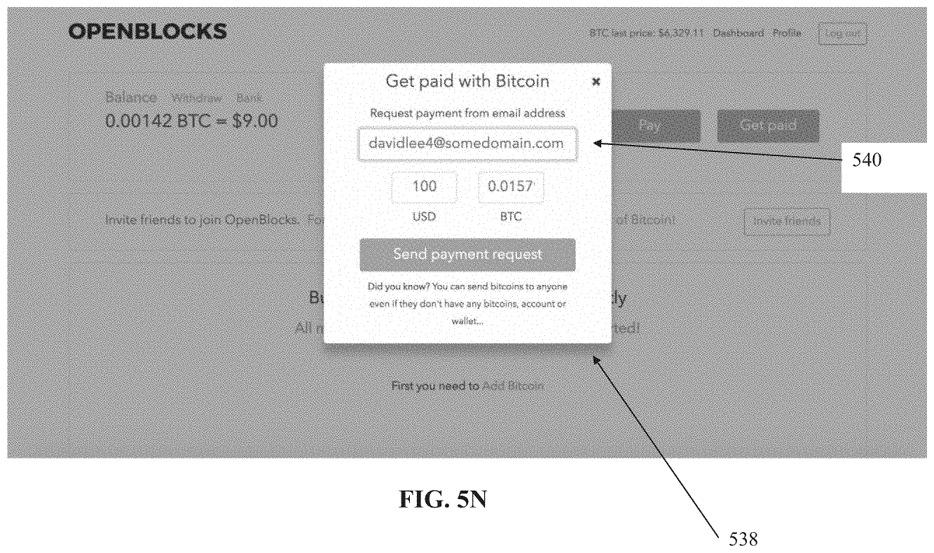

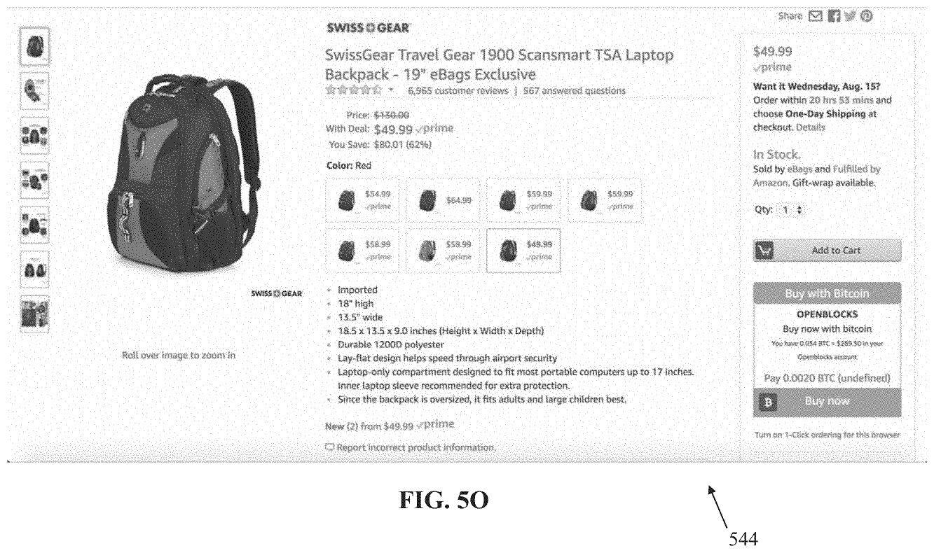

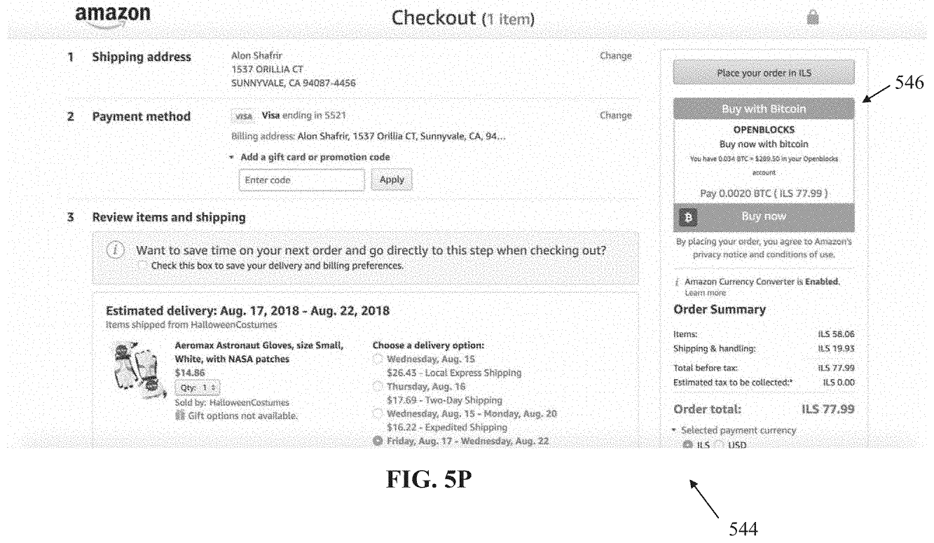

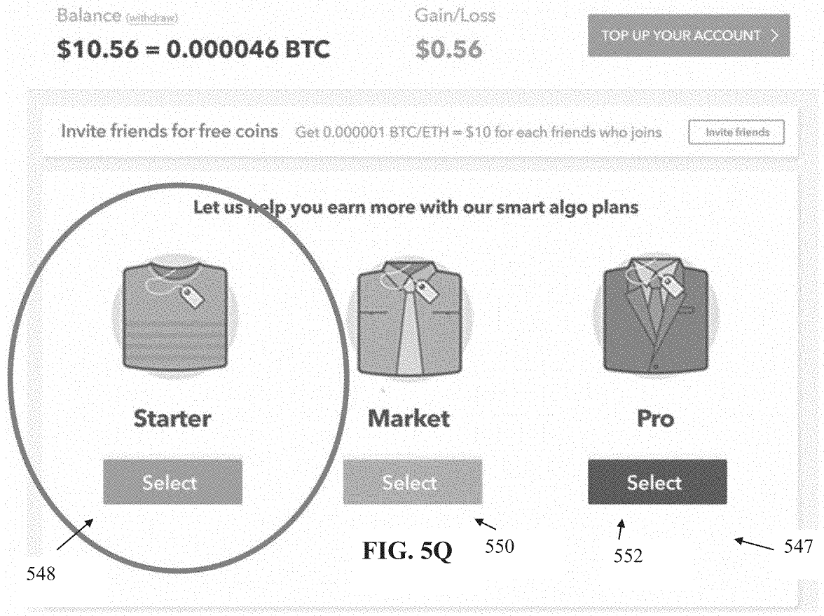

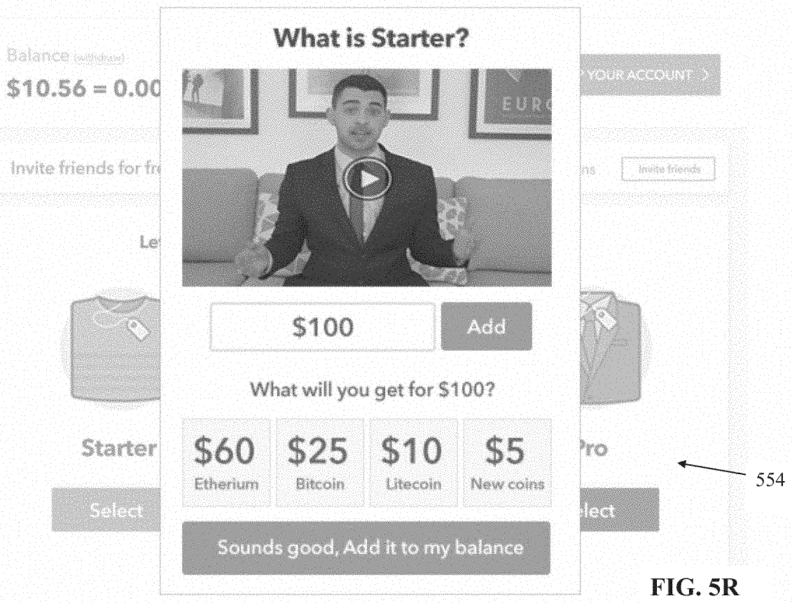

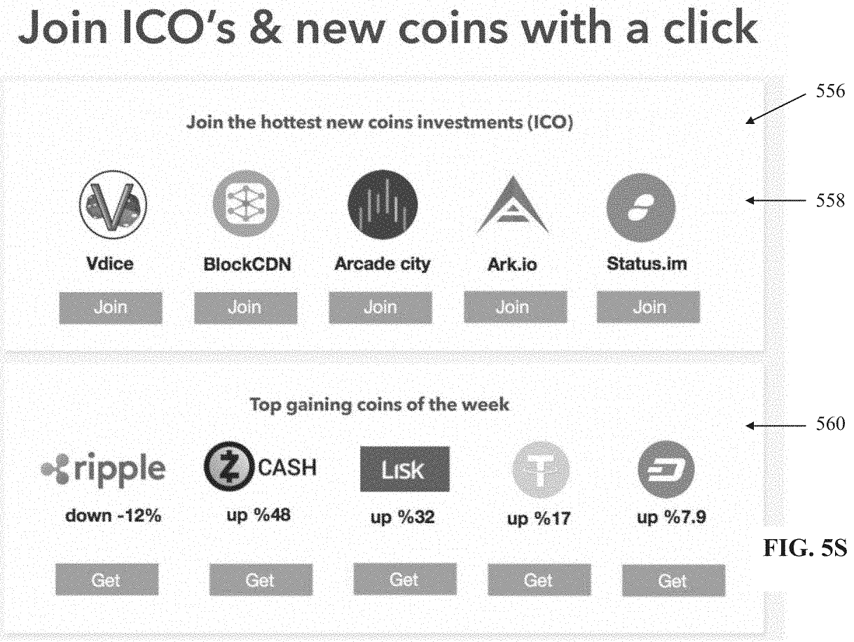

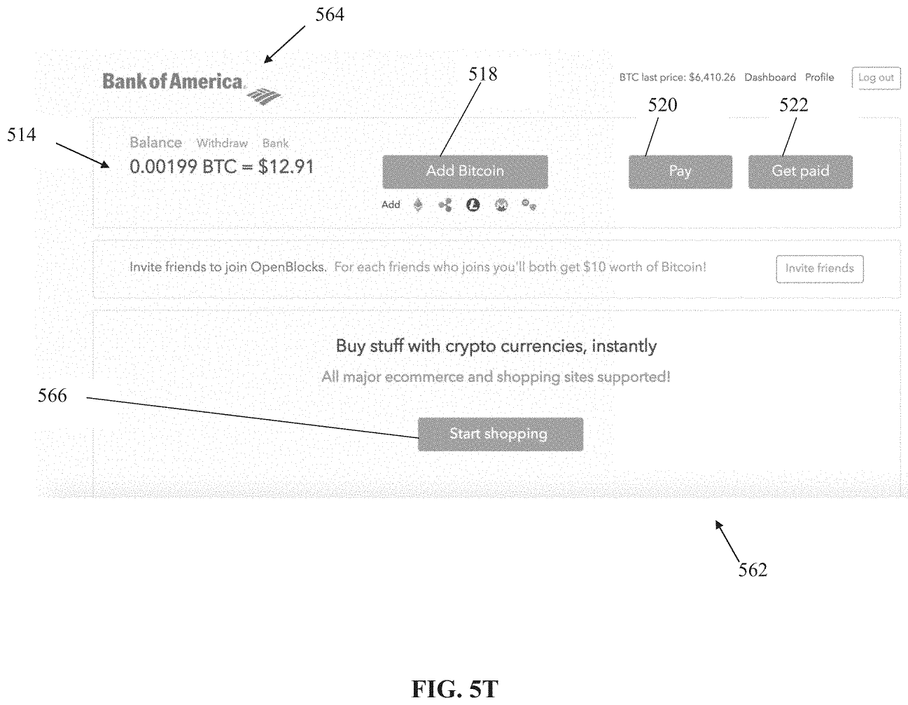

Reference is now made to FIGS. 5A-5T, which includes schematics (i.e., screens) of an exemplary GUI for accessing cryptocurrency stored in a universal wallet and/or for performing transactions using the cryptocurrency, in accordance with some embodiments of the present invention. The GUI enables users to use user credentials for accessing the cryptocurrency, without requiring access to a private wallet. Conceptually, the GUI provides a wallet free architecture to the user, since the users do not directly access the universal wallet. The GUI presented in FIGS. 5A-5T may correspond to one or more features described with reference to FIGS. 2-4 and/or 6. The GUI may be implemented by components of system 200 described with reference to FIG. 2. It is noted that FIGS. 5A-5T do not necessarily represent a flow, and may be executed independently, for example, in response to user selection. The GUI makes the universal wallet transparent to the user. The GUI provides a management layer via which the user may perform transactions using the cryptocurrency, optionally selecting from a set of predefined rules. The selection from the set of predefined rules may be performed using a single click. The GUI acts as a layer over the existing cryptocurrency blockchain and/or ledger infrastructure, and acts as an interface such that the blockchain and/or ledge is transparent to the user. The GUI is designed to provide a user with the ability to use cryptocurrency in place of “real money” such as FIAT currency, for example, for paying with Bitcoin to purchase a book on an online bookstore that accepts US dollars. The GUI may interface with the website, while being transparent to the website and/or without necessarily requiring the website to install code to interface with the GUI. The GUI is designed to improve the user experience of performing transactions using cryptocurrency, by providing a platform for non-technical oriented users to easily perform cryptocurrency transactions.

FIG. 5A presents an exemplary login screen 502 in which a user enters an email address (or other user credential such as phone number and/or username) into a login field 504. As described herein, the user credentials are linked to the cryptocurrency stored in the universal wallet, which is in contrast to standard processes where the wallet is anonymous.

FIG. 5B presents exemplary login screen 502 in which the user entered an email address into login field 504.

FIG. 5C presents exemplary password selection screen 506 in which a user may enter a selected password into password field 508. The combination of user credentials and password (or as used herein, the term user credentials may refer to the combination of the user credential such as email and the password) is used to access the cryptocurrency stored in the universal wallet in contrast to standard processes that use a wallet private key to access the private wallet of the user. The private key is anonymous, not tied to the user, and prone to security breaches, while the user credentials are linked to the user and may use standard authentication processes and/or recover processes.

FIG. 5D presents an exemplary welcome screen 509 in which a user is presented with the amount of cryptocurrency associated with their user credentials that is stored in the universal wallet. It is noted that screen 509 converts the cryptocurrency amount into a selected FIAT, such as US dollar. A selection of icon 510 triggers a presentation of the amount of cryptocurrency associated with the user credentials that is stored in the universal wallet.

FIG. 5E presents an exemplary account balance and transaction screen 512. The account balance 514 is presented in cryptocurrency and converted into one or more selected FIAT currencies. The account balance is obtained according to the dataset that maps the user credentials to the universal wallet. A selection of icon 516 triggers the process of withdrawing cryptocurrency, optionally into a bank account by converting into FIAT currency, as described herein. A selection of icon 518 triggers the process of adding cryptocurrency, optionally by converting FIAT currency, as described herein. A selection of icon 520 triggers the process of transferring cryptocurrency, optionally converted into FIAT currency, to a target entity, optionally according to user credentials of the target entity, as described herein. A selection of icon 522 triggers the process of receiving currency, either FIAT and/or cryptocurrency, from another user, optionally according to user credentials of the other user, as described herein.

FIG. 5F presents an exemplary pop-up window 524 for purchasing cryptocurrency using FIAT currency which is converted into the cryptocurrency, as described herein. Pop-up window 524 appears in response to selection of icon 518 of screen 512 of FIG. 5E.

FIG. 5G presents an exemplary pop-up window 526 for purchasing cryptocurrency using FIAT currency charged to a credit card, as described herein. The cryptocurrency is deposited into the universal wallet, as described herein.

FIG. 5H presents an exemplary pop-up window 528 for sending cryptocurrency and/or FIAT currency to a user according to an email address of the user entered into an email address field 530, as described herein. Pop-up window 528 appears in response to selection of icon 520 of screen 512 of FIG. 5E.

FIG. 5I presents pop-up window 528, where the selected amount of cryptocurrency and/or FIAT currency is being sent to the email address entered in email address field 530, as described herein.

FIG. 5J presents an exemplary email 532 sent to the email address (entered in address field 530 of window 528 of FIG. 5I) of the user destined to receive the cryptocurrency and/or FIAT currency. The email includes a message indicating, for example, how much cryptocurrency and/or FIAT currency is being sent, and from which user it is being sent (i.e., the user credentials, such as email address, of the sending user). The receiving user may obtain the transferred cryptocurrency and/or FIAT currency by clicking on a link 534, as described herein.

FIG. 5K presents an exemplary pop-up window 536 indicative of successful transfer of the cryptocurrency and/or FIAT currency to the destination email address (i.e., user credentials) and/or indicative of successful generation and transmission of the email to the destination email address, as described herein.

FIG. 5L presents account balance and transaction screen 512 as described with reference to FIG. 5E, where the account balance is updated in response to the transfer of cryptocurrency and/or FIAT currency as described with reference to FIGS. 5H-5K, as described herein.

FIG. 5M presents a pop-up window 538 for requesting payment from a user according to an email address of the user entered into an email address field 540. Pop-up window 538 appears in response to selection of icon 522 of screen 512 of FIG. 5E. The user may enter the requested amount of cryptocurrency and/or FIAT currency into a field 542.

FIG. 5N presents pop-up window 538 with the email address entered into email address field 540.

FIG. 5O presents an exemplary website 544 of an online retailer presented within a web browser of a client terminal of a user, as described herein. Website 544 only accepts FIAT currency for purchase of items, such as a backpack.

FIG. 5P presents exemplary website 544 which includes an inserted icon 546 providing the option to purchase the selected item using cryptocurrency (e.g., Bitcoin) instead of FIAT currency. The cryptocurrency is withdrawn from the universal wallet, converted into the FIAT currency, and provided to the website, as described herein. Icon 546 may be inserted by client code which is added on to the code of the web browser, without the website being aware of the interface provided by the client code. The client code enhances standard websites that only accepts FIAT currency into websites that accept cryptocurrency payment, without the website being necessarily aware that cryptocurrency is being used, and/or without additional code necessarily being installed on the website to interface with cryptocurrency, as described herein.

FIG. 5Q presents an exemplary screen 547 for single click (e.g., single click using a mouse cursor, single selection by touching with a finger on a touch screen, other single selection mechanisms) selection of a bundle of cryptocurrencies for purchase. For example, a predefined starter bundle of cryptocurrencies 548, a market bundle 550, and a pro bundle 552.

FIG. 5R presents an exemplary screen 554 that explains the bundle make up when starter bundle 548 of screen 546 of FIG. 5Q is selected. For example, $100 buys a bundle that includes the predefined ratio corresponding to the following amounts: $60 Ethereum, $25 Bitcoin, $10 Litecoin, and $5 other New coins.

FIG. 5S presents an exemplary screen 556 for single click purchase of new coin investments 558 and/or single click purchase of top gaining coins 560 defined according to a set of rules, as described herein.

FIG. 5T presents an exemplary screen 562 of a GUI accessing a financial account (e.g., bank account) 564 hosted by a financial institution server (e.g., bank) that is enhanced to provide one or more features described herein within the GUI of the bank account. For example, while accessing the FIAT bank account, a user may execute one or more features, for example, view cryptocurrency balance in the universal wallet 514, withdraw cryptocurrency 516, add cryptocurrency 518, pay another user (e.g., using cryptocurrency) 520, and get paid 522, as described herein and/or with reference to FIG. 5E. The user may shop online 566 for items being sold for FIAT currency but pay using cryptocurrency, as described herein.

Reference is now made to FIG. 6, which is a flowchart of an exemplary process for requesting to be provided with a target amount of a target currency by another user, in accordance with some embodiments of the present invention.

At 602, a request is received for obtaining a target amount of a target currency from a target entity. It is noted that the target entity may provide a source currency of an amount corresponding to the target amount of the target currency.

The request may be provided, for example, for transferring the target amount of the target currency, for paying the user, and/or for buying an item, for example, as a request for payment, for example, in response to a service and/or product provided by the user to the target entity.

The target currency may be selected by the user, for example via the GUI. The target currency may be a preset currency, for example, predefined by the user and/or according to system configuration.

The target currency may be a cryptocurrency and/or non-cryptocurrency such as a FIAT currency.

The request may be for providing the target amount of the target currency according to a corresponding value of one or more selected source cryptocurrencies, for example, receive $100 worth of Bitcoin from johndoe@johndoe.com.

The request may be received from a client terminal over a network. The request may be entered by the user, for example, via the GUI and/or client code installed on the client terminal.

The target entity may be another user, which may or not may be registered with the computing device. The another user is denoted by user credentials, for example, email and/or phone number. When the target entity is based on user credentials that are not registered with the computing device, the target entity may be registered as a new user, for example, as described herein.

At 604, the target entity is provided with instructions to provide the target amount of the target currency, for example, via an email with link sent to the email of the target entity, a pop-up window sent to the client terminal of the target entity.

At 606, the target entity provides the target amount of the target currency, for example, as described herein.

The target entity may access the target currency stored in the universal wallet and/or access FIAT currency for example, via a financial server and/or credit card, as described herein.

The target entity may select to provide the target currency using a source currency that is different than the target currency. For example, to provide Bitcoin in response to a request from the user to provide US dollars.

At 608, when the source currency is different than the target currency, the source currency is converted to target currency, as described herein.

At 610, the target currency is received and stored as being owned by the user. When the target currency is a cryptocurrency, the target currency is stored in the universal wallet, as described herein. It is noted that the target currency may be transferred to the universal wallet via the temporary wallet, as described herein. When the target currency is FIAT, the target currency may be transferred for storage by the financial server, as described herein. Alternatively, when the target entity is registered with the computing device and the source currency is stored in the universal wallet and the target currency is the same as the source currency, the target currency is not received and stored. In such case, the user dataset and/or transaction dataset is updated to reflect transfer of ownership of the cryptocurrency stored in the universal wallet(s) without necessarily transferring the cryptocurrency out of the universal wallet(s).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant cryptocurrencies and wallets will be developed and the scope of the terms cryptocurrency and wallet are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In the claims:

1. A system for transferring and providing security of cryptocurrency over a network, comprising:
at least one hardware processor;
a non-transitory memory stored thereon code for execution by the at least one hardware process, the code including instructions for:
receiving a request from a client terminal over a network, for providing a target amount of at least one target currency to a destination entity according to a corresponding value of at least one cryptocurrency,
wherein the request includes a user credential and excludes a wallet address and/or a wallet key of the at least one universal wallet, and a wallet address and/or a wallet key of a personal wallet associated with the user credentials;
accessing, according to the user credential the at least one cryptocurrency stored in at least one universal wallet stored on a data storage device,
wherein each universal wallet stores cryptocurrency for a plurality of users according to a plurality of user credentials of the corresponding plurality of users,
wherein a user dataset stores a mapping between each of the plurality of user credentials and amount of cryptocurrency stored in the at least one universal wallet;
generating instructions for providing the target amount of the at least one target currency to the destination entity according to the at least one cryptocurrency; and
updating the user dataset at least according to corresponding value of the at least one cryptocurrency to indicate a new amount of the at least one cryptocurrency stored in the at least one universal wallet and mapped to the user credential.

2-3. (canceled)

4. The system according to claim 1, further comprising instructions for:
accessing an empty temporary wallet stored on a memory;
disconnecting the temporary wallet from a network connection;
synchronizing, when offline and disconnected from the network connection, an amount of the at least one cryptocurrency corresponding to the target amount of the target currency with the temporary wallet,
wherein the universal wallet is stored in a first data storage device disconnected from the network connection,
wherein the temporary wallet is stored in a second data storage device connected to the network connection; and
re-connecting the temporary wallet to the network connection
wherein the empty temporary wallet is at least one of:
(i) a new temporary wallet created for each transaction of providing cryptocurrency, and
(ii) an existing temporary wallet used for temporary storage of cryptocurrency for another user, wherein the temporarily stored cryptocurrency is removed to create the empty temporary wallet.

5-8. (canceled)

9. The system according to claim 1, wherein the user credentials is selected from the group consisting of: email, phone number, username, a universal ID, and a non universal ID.

10-11. (canceled)

12. The system according to claim 1, wherein the converting comprise generating instructions for execution by an application programming interface (API) for exchanging an amount of the at least one cryptocurrency into the target amount of the target currency.

13. The system according to claim 1, wherein the target currency comprises a FIAT currency, and the generated instructions include instructions for at least one of: (i) depositing the target amount of the target currency into a financial account of the destination entity stored by a financial server, and (ii) for transferring the target amount of the target currency to a website of the destination entity.

14. (canceled)

15. The system according to claim 1, further comprising client code for installation by a financial server hosting FIAT financial accounts of users, wherein the client code includes instructions for presenting within a GUI during access of a certain FIAT financial account, an object that when selected provides the request from the client terminal accessing the certain financial account of the financial server.

16. The system according to claim 1, further comprising client code for installation by at least one of (i) the client terminal as an add-on to a browser executed by the client terminal and (ii) in association with a website hosted by a server, wherein the client code includes code for interfacing with a website rendered by the browser wherein the website presents items for purchase using FIAT, for presenting in the browser an icon providing an option to purchase a certain item using an amount of cryptocurrencies stored in the universal wallet and mapped to the user credentials that is converted from the amount of FIAT for purchasing the certain item, and for transmitting the request for transferring the target amount of the target currency to the destination entity according to the corresponding value of at least one cryptocurrency, wherein the icon is presented on the destination entity comprising at least one of: the website, a checkout web page accessed from the website, a credit card payment form accessed from the website, and any supported web page linked to the website and accessed via the website.

17. The system according to claim 16, wherein the code includes instructions for presenting a graphical user interface (GUI) for manual user selection of execution of the request of transferring the target amount of the target currency to the website according to the corresponding value of the at least one cryptocurrency.

18. The system according to claim 16, wherein the code includes instructions for presenting a GUI that presents the corresponding value of the at least one cryptocurrency and for presenting a remaining balance of the cryptocurrencies stored in the universal wallet and mapped to the user credentials.

19. The system according to claim 16, wherein the client code includes instructions to set the target amount and the target currency for the destination entity according to the website.

20. The system according to claim 17, wherein the GUI is presented as a window inserted into the rendered website, and wherein the GUI includes a button for manual selection by the user for execution of the request.

21. The system according to claim 17, wherein the manual user selection triggers payment of the target amount of the target currency to the website for purchase of at least one item or service using the corresponding value of the at least one cryptocurrency.

22. The system according to claim 16, wherein the website comprises a website in which a payment and/or purchase of items or service is provided, and the target amount and the target currency are set according at least one item presented on the website and available for purchase via the website.

23. The system according to claim 16, wherein the code includes instructions for presenting a GUI for user selection of the at least one cryptocurrency according to cryptocurrencies stored in the universal wallet and mapped to the user credentials.

24. The system according to claim 1, further comprising client code for installation as an independent application by a mobile device implemented as the client terminal, wherein the client code includes code for interfacing with a website that presents items for purchase using FIAT, for presenting on the display of the mobile device an icon providing an option to purchase a certain item using an amount of cryptocurrencies stored in the universal wallet and mapped to the user credentials that is converted from the amount of FIAT for purchasing the certain item, presenting a remaining balance of the cryptocurrencies stored in the universal wallet and mapped to the user credentials, and for transmitting the request for transferring the target amount of the target currency to the destination entity according to the corresponding value of at least one cryptocurrency, wherein the icon is presented on the destination entity comprising at least one of: the website, a checkout web page accessed from the website, a credit card payment form accessed from the website, and an external web page linked to the website and accessed via the website.

25. The system according to claim 1, wherein the target currency is a FIAT currency.

26-27. (canceled)

28. The system according to claim 1, wherein the target amount of the target currency converted from the at least one cryptocurrency is provided to the destination entity according to user credentials of the destination entity and the user credentials and not according to private wallet addresses of the destination entity and the user associated with the user credentials.

29. The system according to claim 1, wherein a user associated with the user credentials is denied direct access to the universal wallet for direct deposit and/or withdrawal of cryptocurrency.

30. The system according to claim 1, further comprising a user dataset storing mapping between a plurality of user credentials and corresponding amounts of at least one cryptocurrency stored in the universal wallet, and wherein when the destination entity comprises a destination user credential stored in the user dataset, the generated instructions for providing the target amount of the target currency to the destination entity comprises instructions for updating the user dataset, wherein the user dataset is updated and an external distributed ledger blockchain dataset storing records of cryptocurrency transactions is not updated, and
wherein the target amount of the target currency is provided to the destination entity using the same universal wallet that stores at least one cryptocurrency for the user credentials and for the destination user credential by updating the user dataset to indicate transfer of ownership of the target currency from the destination user credentials to the user credentials without transfer of the target amount of the target currency out of the same universal wallet.

31-34. (canceled)

35. The system according to claim 1, further comprising a user dataset storing mapping between a plurality of user credentials and corresponding amounts of at least one cryptocurrency stored in the universal wallet, and wherein when the destination entity comprises a destination user credential not stored in the user dataset, further comprising instructions for transmitting a link to the destination user credentials to set up a record in the user dataset, and wherein the generated instructions for providing the target amount of the target currency to the destination entity comprises instructions for updating the user dataset according to the record of the destination user credential.

36. The system according to claim 1, further comprising code for:
withdrawing the at least one cryptocurrency from the universal wallet associated with the user credential;
converting the at least one cryptocurrency to a target amount of a FIAT of the at least one target currency
depositing the FIAT in at least one FIAT source selected from the group consisting of: (i) credited to a credit card associated with the user credentials stored in a data storage device and accessible by the at least one hardware processor, (ii) credited to a credit card number associated with the user credentials and manually entered by the user credentials via a user interface, and (iii) in a FIAT financial account of the user credentials;
wherein the destination entity comprises a FIAT financial account hosted by a financial server,
transferring the target amount of the FIAT of the one target currency to the destination entity from the at least one FIAT source associated with the user credentials,
wherein the user dataset stores a mapping of the FIAT financial account and credit card, and the user credentials.

37. A system for providing cybersecurity for obtaining at least one cryptocurrency over a network, comprising:
at least one hardware processor;
a non-transitory memory stored thereon code for execution by the at least one hardware process, the code including instructions for:
receiving a request from a client terminal over a network, for obtaining a target amount of at least one target cryptocurrency according to a corresponding value of a source currency,
wherein the request includes a user credential and excludes a wallet address and/or a wallet key of the at least one universal wallet, and excludes a wallet address and/or a wallet key of a personal wallet associated with the user credentials;
obtaining an amount of a source currency corresponding to the target amount of the at least one target cryptocurrency;
converting the amount of the source currency to the target amount of the at least one target cryptocurrency;
storing, according to the user credential, the target amount of the at least one target cryptocurrency in at least one universal wallet stored on a data storage device,
wherein each universal wallet stores cryptocurrency for a plurality of users according to a plurality of user credentials of the corresponding plurality of users,
wherein a user dataset stores a mapping between each of the plurality of user credentials and amount of cryptocurrency stored in the at least one universal wallet; and
updating the user dataset at least according to corresponding value of the at least one target cryptocurrency to indicate a new amount of the at least one cryptocurrency stored in the at least one universal wallet and mapped to the user credential.

38. The system according to claim 37, further comprising instructions for:
storing the target amount of the at least one target cryptocurrency in a temporary wallet stored on a memory in communication with a network connection;
disconnecting the temporary wallet from the network connection; and
synchronizing, when offline and disconnected from the network connection, the target amount of the at least one target cryptocurrency stored in the temporary wallet with the universal wallet stored in a data storage device disconnected from the network connection.

39. The system according to claim 38, further comprising instructions for:
removing the contents of the temporary wallet to empty the temporary wallet, and re-connecting the temporary wallet to the network connection.

40. The system according to claim 39, wherein the temporary wallet comprises a same temporary wallet used by a plurality of discrete users.

41. The system according to claim 38, further comprising instructions for:
deleting the temporary wallet or blocking further access to the temporary wallet, and creating a new temporary wallet connected to the network connection, for storage of a new target amount of at least one new target cryptocurrency.

42. The system according to claim 37, wherein the target amount of each type of cryptocurrency of a certain user is divided and stored by a plurality of universal wallets each designed to store the same type of cryptocurrency.

43. The system according to claim 37, wherein the source currency is a FIAT currency.

44. The system according to claim 37, wherein the target amount is according to a selection from a set of predefined rules defining a plurality of combinations of a plurality of target cryptocurrencies.

45. The system according to claim 44, wherein the target amount is selected with a single click from a graphical user interface (GUI) that displays the plurality of combinations of the plurality of target cryptocurrencies, and wherein the selected combination of the plurality of target cryptocurrencies is obtained by converting the amount of the source currency to the target amount of the at least one target cryptocurrency in response to the single click.

46. The system according to claim 44, wherein the plurality of combinations are of at least one of: initial coin offerings (ICO), and security token offerings, wherein the target amount of the plurality of combinations is selected with a single click from a GUI, wherein in response to the single click user data is automatically transferred for automatic registration of a user associated with the user credentials for obtaining the selected combination of at least one of: initial coin offerings (ICO), and security token offerings.

47. The system according to claim 37, wherein converting comprises generating instructions for execution by an application programming interface (API) of an exchange server for obtaining the target amount of the at least one target cryptocurrency.

48. The system according to claim 37, further comprising instructions for obtaining FIAT from a financial server storing financial data of a user using the client terminal and associated with the user credentials, and wherein the FIAT is converted to the target amount of the at least one target cryptocurrency.

49. A system for providing cybersecurity for managing FIAT and cryptocurrency using a single GUI and over a network, comprising:
at least one hardware processor;
a non-transitory memory stored thereon code for execution by the at least one hardware process, the code including instructions for:
generating instructions for presenting, within a GUI on a display of a client terminal, at least one icon presented within a single common interface for performing at least one transaction including at least one FIAT currency and at least one cryptocurrency,
wherein the FIAT currency is stored in at least one FIAT financial account hosted by a financial server,
wherein the at least one cryptocurrency is stored in at least one universal wallet on a data storage server, wherein each universal wallet stores cryptocurrency for a plurality of users according to a plurality of user credentials of a the corresponding plurality of users,
wherein a user dataset stores a mapping between each of the plurality of user credentials and amount of cryptocurrency stored in the at least one universal wallet and FIAT financial accounts;
in response to the selection of the at least one icon for performing the at least one transaction, updating the user dataset to indicate a new amount of the at least one cryptocurrency stored in the at least one universal wallet and mapped to the user credentials,
wherein a new amount of the at least one FIAT currency stored in the FIAT financial account is updated according to the selection of the at least one icon for performing the at least one transaction.

50. The system of claim 49, wherein the at least one transaction including at least one FIAT currency and at least one cryptocurrency is selected from the group consisting of: obtaining additional at least one cryptocurrency using the at least one FIAT currency, converting from the at least one cryptocurrency to the at least one FIAT currency, converting from the at least one FIAT currency to the at least one cryptocurrency, providing from the at least one cryptocurrency to a destination entity, providing from the at least one FIAT currency to a destination entity, withdrawing from the at least one cryptocurrency and transferring a corresponding converted amount to the at least one FIAT currency, providing a request to receive an amount of at least one cryptocurrency from a target entity, and providing a request to receive an amount of at least one FIAT currency from a target entity.

51. The system according to claim 1, further comprising client code for installation as an independent application by a mobile device implemented as the client terminal, wherein the client code includes code for interfacing with the destination entity that provides items for purchase using FIAT, for presenting on the display of the mobile device an icon providing an option to purchase a certain item using an amount of cryptocurrencies stored in the universal wallet and mapped to the user credentials that is converted from the amount of FIAT for purchasing the certain item, presenting a remaining balance of the cryptocurrencies stored in the universal wallet and mapped to the user credentials, and for transmitting the request for transferring the target amount of the target currency to the destination entity according to the corresponding value of at least one cryptocurrency.

52. The system according to claim 51, wherein the target amount of the target currently is transmitted to the destination entity using at least one of: (i) via a wireless connection from the mobile device to a device of the destination entity, and (ii) using a credit card number provided to the destination entity.
